(19) United States
(12) Patent Application Publication
(10) Pub. No.: US 2025/0056479 A1
(43) Pub. Date: Feb. 13, 2025

(54) TECHNIQUES FOR SIDELINK POSITIONING USING DEVICE RESOURCE INFORMATION

(71) Applicant: QUALCOMM Incorporated, San Diego, CA (US)

(72) Inventor: Stephen William EDGE, Escondido, CA (US)

(21) Appl. No.: 18/795,646

(22) Filed: Aug. 6, 2024

Related U.S. Application Data
(60) Provisional application No. 63/518,409, filed on Aug. 9, 2023.

(51) Int. Cl. H04W 64/00; H04L 5/00; H04W 8/22; H04W 92/18

(52) U.S. Cl. CPC H04W 64/00; H04L 5/0007; H04L 5/0051; H04W 8/22; H04W 92/18

(57) ABSTRACT

Techniques are disclosed for utilizing resource capability maps and resource usage maps for sidelink (SL) positioning among a group of user equipments (UEs). According to some aspects, each UE of the group of UEs may send, to a coordinating entity (e.g., a UE or a server), resource information comprising: (1) a resource capability map indicative of the respective UE's capability of transmitting an SL positioning signal, receiving an SL positioning signal, or both, using one or more frequencies; and/or (2) a resource usage map indicative of the respective UE's scheduled usage of SL positioning time and frequency resources, the scheduled usage comprising transmitting an SL positioning signal and/or receiving an SL positioning signal. The coordinating entity can determine an SL positioning configuration for each UE in the group based at least in part on the resource information and send the SL positioning configurations to these UEs.

### RELATED APPLICATIONS

This application claims the benefit of U.S. Provisional Application No. 63/518,409, filed Aug. 9, 2023, entitled “5G SIDELINK RESOURCE USAGE MAPS”, which is assigned to the assignee hereof, and incorporated herein in its entirety by reference.

### BACKGROUND

The subject matter disclosed herein relates to wireless communications systems, and more particularly to systems, methods, and devices that support positioning.

Wireless communication systems are widely deployed to provide various telecommunication services such as telephony, video, data, messaging, positioning, and broadcasts. Typical wireless communication systems may employ multiple-access technologies capable of supporting communication with multiple users by sharing available system resources (e.g., bandwidth, transmit power). Examples of such multiple-access systems include fourth-generation (4G) systems such as Long-Term Evolution (LTE) systems, LTE-Advanced (LTE-A) systems, or LTE-A Pro systems, and fifth-generation (5G) systems which may be referred to as New Radio (NR) systems.

In some examples, a wireless multiple-access communication system may include a number of base stations, each simultaneously supporting communication for multiple communication devices, otherwise known as user equipment (UEs). A base station may communicate with a set of UEs on downlink channels (e.g., for transmissions from a base station to a UE) and uplink channels (e.g., for transmissions from a UE to a base station). Additionally, UEs may communicate directly with each other using sidelink channels.

A location of a UE may be useful or essential to a number of applications including emergency calls, navigation, direction finding, asset tracking and Internet service. The UE may compute an estimate of its own location using the positioning measurements in UE-based positioning or may send the positioning measurements to a network entity, e.g., location server, which may compute the UE location based on the positioning measurements in UE-assisted positioning. Additionally, sidelink positioning among a group of UEs may be used in which each UE may transmit signals to other UEs and/or measure signals received from other UEs. However, means to efficiently and effectively determine the signals to be transmitted and measured by each UE are not yet fully known.

### BRIEF SUMMARY

Techniques are disclosed for utilizing resource capability maps and/or resource usage maps for sidelink (SL) positioning among a group of UEs. According to some aspects, each UE of the group of UEs may send, to a coordinating entity (e.g., a UE in the group or a server), resource information comprising either or both of: (1) a resource capability map indicative of the respective UE's capability of transmitting an SL positioning signal, receiving an SL positioning signal, or both, using one or more frequencies; or (2) a resource usage map indicative of the respective UE's scheduled usage of SL positioning time and frequency resources, the scheduled usage comprising transmitting an SL positioning signal, receiving an SL positioning signal, or both. The coordinating entity can then determine an SL positioning configuration based at least in part on the resource information and send the SL positioning configuration to the UEs in the group.

An example method performed by a coordinating entity for supporting sidelink (SL) positioning of a plurality of UEs, according to this disclosure, comprises obtaining resource information for each of the plurality of UEs, wherein, for each respective UE, the resource information comprises either or both of: a resource capability map indicative of the respective UE's capability of transmitting an SL positioning signal, measuring an SL positioning signal, or both, using one or more frequencies; or a resource usage map indicative of the respective UE's scheduled usage of SL positioning time and frequency resources, the scheduled usage comprising transmitting an SL positioning signal, measuring an SL positioning signal, or both. The method may further comprise determining an SL positioning configuration for each respective UE of the plurality of UEs, wherein the determining is based at least in part on the resource information of each respective UE of the plurality of UEs. The method may further comprise sending the SL positioning configuration to each respective UE of the plurality of UEs.

An example method performed by a UE for sidelink (SL) positioning, according to this disclosure, comprises determining resource information, the resource information comprising either or both of: a resource capability map indicative of the UE's capability of transmitting an SL positioning signal, measuring an SL positioning signal, or both, using one or more frequencies; or a resource usage map indicative of the UE's scheduled usage of SL positioning time and frequency resources, the scheduled usage comprising transmitting an SL positioning signal, measuring an SL positioning signal, or both. The method may further comprise providing the resource information to an entity coordinating SL positioning among a plurality of UEs, the plurality of UEs comprising the UE.

An example coordinating entity, according to this disclosure, comprises: at least one transceiver; at least one memory; and at least one processor communicatively coupled with the at least one transceiver and at least one memory. The at least one processor is configured to: obtain resource information for each of a plurality of user equipments (UEs). For each respective UE of the plurality of UEs, the resource information may comprise either or both of: a resource capability map indicative of the respective UE's capability of transmitting a sidelink (SL) positioning signal, measuring an SL positioning signal, or both, using one or more frequencies; or a resource usage map indicative of the respective UE's currently scheduled usage of SL position frequency and time resources, the scheduled usage comprising transmitting an SL positioning signal, measuring an SL positioning signal, or both. The at least one processor may be further configured to determine an SL positioning configuration for each respective UE of the plurality of UEs, wherein the determining is based at least in part on the resource information obtained for each respective UE of the plurality of UEs. The at least one processor may be further configured to provide the SL positioning configuration via the at least one transceiver to each respective UE of the plurality of UEs.

An example user equipment (UE), according to this description, comprises: at least one transceiver; at least one memory; and at least one processor communicatively coupled with the at least one transceiver and at least one memory. The at least one processor is configured to: determine resource information, the resource information comprising either or both of: a resource capability map indicative of the UE's capability of transmitting a sidelink (SL) positioning signal, measuring an SL positioning signal, or both, using one or more frequencies; a resource usage map indicative of the UE's currently scheduled usage of SL position frequency and time resources, the scheduled usage comprising transmitting an SL positioning signal, measuring an SL positioning signal, or both. The at least one processor may be further configured to provide the resource information via the at least one transceiver to an entity coordinating SL positioning among a plurality of UEs, the plurality of UEs including the UE.

An example apparatus for supporting sidelink (SL) positioning of a plurality of user equipments (UEs), according to this description, comprises means for obtaining resource information for each of the plurality of UEs, wherein, for each respective UE of the plurality of UEs, the resource information comprises either or both of a resource capability map indicative of the respective UE's capability of transmitting an SL positioning signal, measuring an SL positioning signal, or both, using one or more frequencies; or a resource usage map indicative of the respective UE's currently scheduled usage of SL positioning frequency and time resources, the scheduled usage comprising transmitting an SL positioning signal, measuring an SL positioning signal, or both. The apparatus further may comprise means for determining an SL positioning configuration for each respective UE of the plurality of UEs. The determining may be based at least in part on the resource information obtained for each respective UE of the plurality of UEs. The apparatus further may comprise means for providing the SL positioning configuration to each respective UE of the plurality of UEs.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 shows an architecture of a communication system including a number of UEs, a Radio Access Network (RAN), and a 5G Core Network (5GC).

FIG. 2 shows an architecture of a communication system for network-supported sidelink positioning.

FIG. 3 is a signal flow illustrating signaling between UEs and a location server for network-supported sidelink positioning.

FIGS. 4A and 4B are block diagrams illustrating implementations of the structure of a sidelink positioning protocol (SLPP) message.

FIG. 5 is a signal flow illustrating the signaling between a pair of UEs for pairwise sidelink positioning.

FIG. 6A is a signal flow illustrating the signaling between UEs for a sidelink positioning capabilities exchange, including the exchange of capabilities, resources, and service requirements.

FIG. 6B is a signal flow illustrating the signaling between UEs for a positioning signal configuration and confirmation exchange.

FIG. 6C is a signal flow illustrating the signaling between UEs for a measurement exchange.

FIG. 7 is a signal flow illustrating the signaling for group operation of sidelink positioning for a plurality of UEs.

FIG. 8 is a diagram of a resource capability map and a resource usage map, according to an embodiment.

FIG. 9 is another diagram of a resource usage map, according to an embodiment.

FIG. 10 is a schematic block diagram illustrating certain exemplary features of a UE that is configured to support sidelink positioning, as discussed herein.

FIG. 11 is a schematic block diagram illustrating certain exemplary features of a location server that is configured for network supported sidelink positioning, as discussed herein.

FIG. 12 is a flow diagram of a method performed by a coordinating entity for supporting sidelink (SL) positioning of a plurality of UEs, according to an embodiment.

FIG. 13 is a flow diagram of a method performed by a UE for sidelink (SL) positioning, according to an embodiment.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Techniques and apparatus are discussed herein for determining wireless resources (e.g., in frequency and/or time domains) for sidelink positioning (SL) between UEs. A Sidelink positioning protocol (SLPP) may be used for supporting sidelink positioning of UEs in pairwise positioning, group operation, as well as network-supported SLPP. The sharing of resource usage and resource capabilities among UEs and/or between UEs and a network is discussed, including sharing “maps” of such usage and/or capabilities with a coordinating entity. A “map” in this context may also be referred to as a “grid”.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, tracking device, Internet of Things (IoT) device, Industrial IoT (IIoT) device, In Vehicle System (IVS), etc.) used to communicate over a wireless communications network. A UE may be mobile or may (e.g., at certain times) be stationary, and may communicate with a Radio Access Network (RAN). For example, as used herein, a UE may be an infrastructure node, such as a roadside unit (RSU), Positioning Reference Unit (PRU), etc. As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” RSU, PRU, IVS, or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, Wi-Fi networks (e.g., based on IEEE 802.11, etc.) and so on.

A base station may operate according to one of several RATs in communication with UEs depending on the network in which it is deployed, and may be alternatively referred to as an Access Point (AP), a Network Node, a NodeB, an evolved NodeB (eNB), a general Node B (gNodeB, gNB), etc. In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, tracking devices, asset tags, vehicles, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). A communication link through which UEs can send signals to other UEs is called a sidelink channel. As used herein the term traffic channel (TCH) can refer to either an uplink/reverse or downlink/forward or sidelink traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

Standardization of cellular systems and positioning support for cellular systems, such as the Fifth Generation (5G) or New Radio (NR) network system, has been performed by the 3rd Generation Partnership Project (3GPP). By way of example, RAT-dependent positioning systems that have undergone standardization include Enhanced Cell ID (E-CID) (using Received Signal Strength (RSS) and Round-Trip Time (RTT) and optionally using Angle of Arrival (AOA)), downlink (DL) positioning, such as Observed Time Difference of Arrival (OTDOA) and Downlink Time Difference of Arrival (DL-TDOA), uplink (UL) positioning, such as Uplink Time Difference of Arrival (UL-TDOA) and uplink Angle of Arrival (UL-AOA). RAT-independent positioning systems that have undergone standardization include assisted Global Navigation Satellite System (A-GNSS), and other technologies such as Wireless Local Area Network (WLAN), Bluetooth®, Terrestrial Beason System (TBS), and sensor-based positioning including barometric sensor and motion sensor. Additionally, Hybrid positioning has undergone standardization, which includes the use of multiple methods for positioning, e.g., A-GNSS+DL-TDOA hybrid positioning.

Standardization of sidelink (SL) positioning has also started in 3GPP. A current unsolved problem for SL positioning among a group of UEs is how to determine positioning signal (e.g., SL positioning reference signal (SL-PRS)) transmission resources and resources to be measured for all of the UEs in some optimum manner. Distributed algorithms (where multiple UEs each separately determine the same transmission and measurement resources) cannot easily be used because (a) the UEs might not know the current transmission and measurement requirements of the other UEs and (b) these algorithms would require standardization which could be slow and might preclude use of better algorithms later. Centralized algorithms in which one server UE or controlling UE (or LMF) determines the transmission and measurement resources for all of the UEs would avoid problem (b) (and avoid any standardization) but would still encounter problem (a).

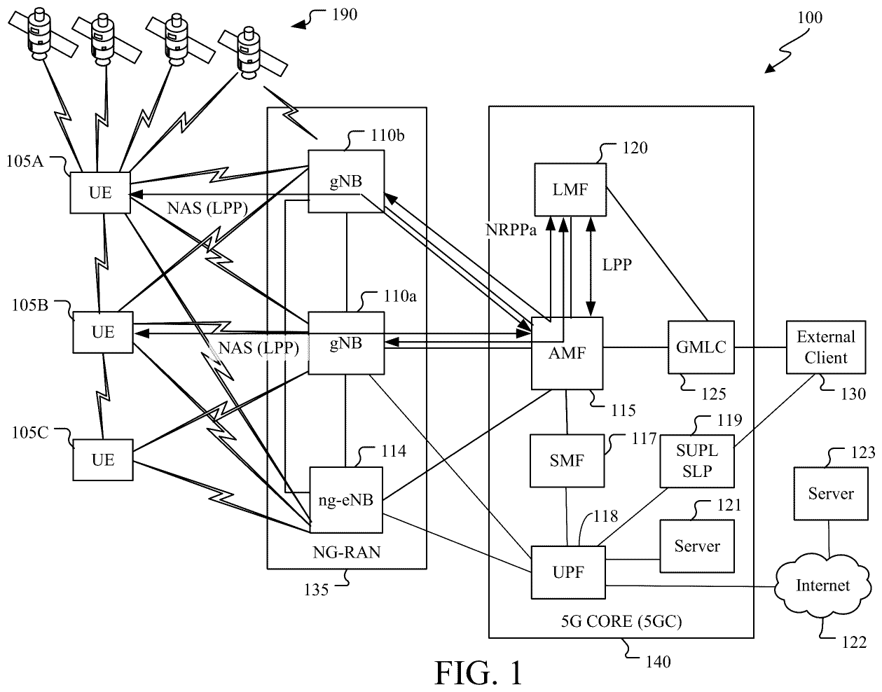

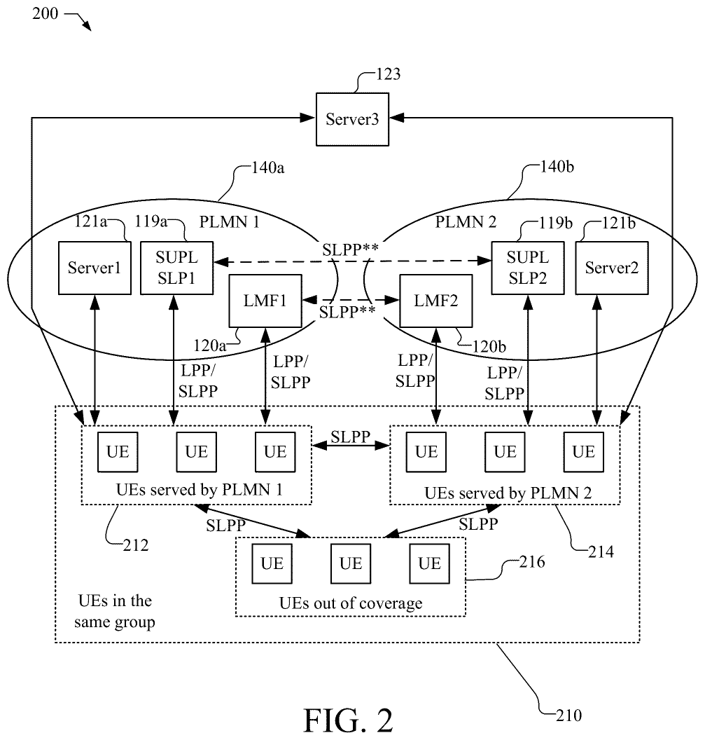

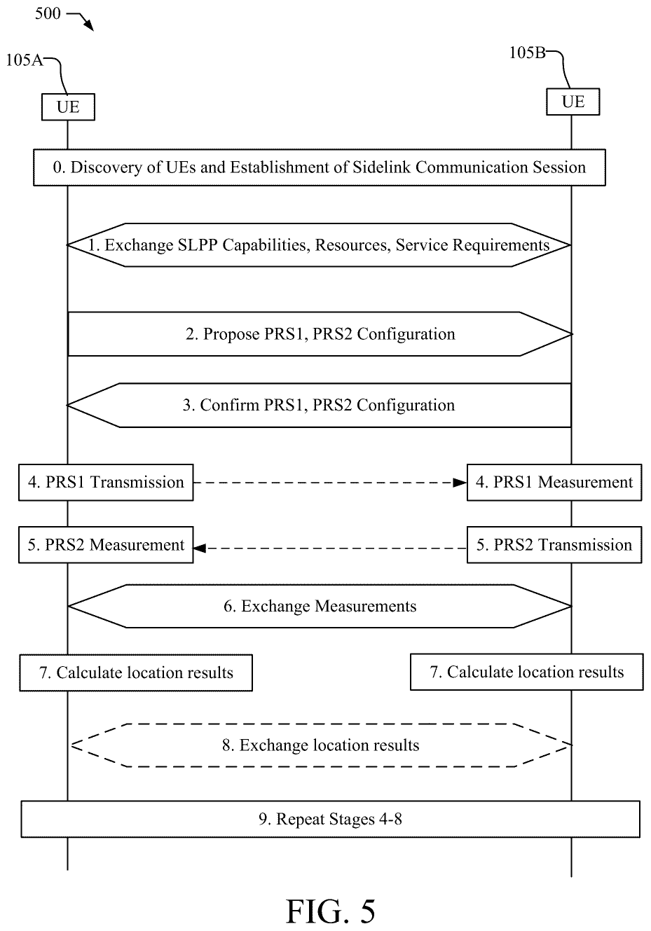

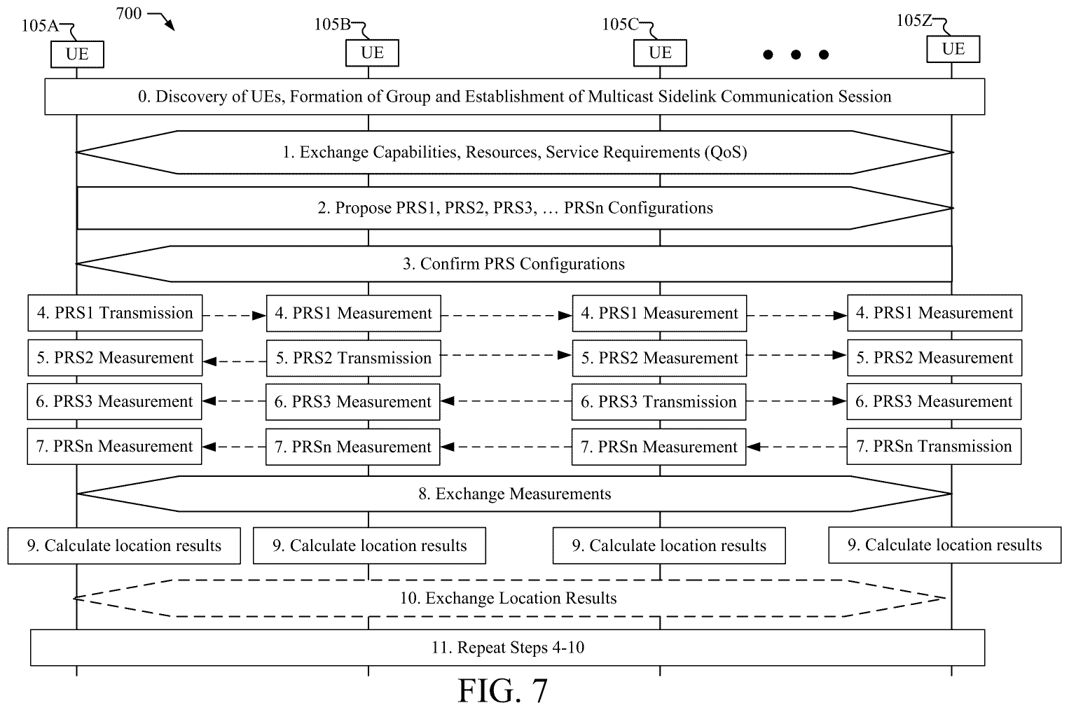

Embodiments described herein address problem (a) and other issues by enabling each UE participating in SL positioning (e.g., an SL positioning session) to provide a resource usage map and resource capability map to a coordinating entity, such as a UE (e.g. UE1 105A in FIG. 5 and FIG. 7) which determines the transmission and measurement resources for all of the UEs, or a network entity (e.g., a location server or location management function (e.g. LMF 120 in FIGS. 1 and 2)).

Various aspects relate generally to SL positioning. Some aspects more specifically relate to sharing transmission and measurement resources with an entity coordinating SL positioning. In some examples, frequency and time SL positioning resources can be quantized in a 2D grid, and UEs may share resource usage “maps” that indicate what resources in the grid are used. The coordinating entity can then more easily determine unused/available resources of a group of UEs by analyzing the resource usage maps of the UEs of the group, and coordinate SL positioning accordingly. In some examples, a resource capability map can show the capability of a UE to transmit and receive/measure SL PRS at different frequencies. In some examples, additional parameters can be included regarding bandwidth, duration, periodicity and UE capability to support these.

Particular aspects of the subject matter described in this disclosure can be implemented to realize one or more of the following potential advantages. In some examples, by sharing transmission and measurement resources with an entity coordinating SL positioning, the described techniques can be used to enable an entity coordinating the SL positioning to efficiently determine SL-PRS transmission resources and resources to be measured for all of the UEs. A person of ordinary skill in the art will recognize these and other advantages in view of the embodiments described below. These embodiments are provided after a review of the relevant technology.

FIG. 1 shows an example of a communication system 100 that includes a first UE 105A, a second UE 105B, a third UE 105C, a Radio Access Network (RAN) 135, here a Fifth Generation (5G) Next Generation (NG) RAN (NG-RAN), and a 5G Core Network (5GC) 140. The 5GC 140, for example, may be a public land mobile network (PLMN). The UEs 105A, 105B and 105C may be sometimes referred to herein as UE 105 individually or UEs 105 collectively. The UE 105 may be, e.g., an IoT device, a location tracker device, a cellular telephone, a vehicle, an On-Board Unit (OBU), or other similar type of device. The UE 105 may additionally be considered an RSU or PRU. A 5G network may also be referred to as a New Radio (NR) network; NG-RAN 135 may be referred to as a 5G RAN or as an NR RAN; and 5GC 140 may be referred to as an NG Core network (NGC). The RAN 135 may be another type of RAN, e.g., a 3G RAN, a 4G Long Term Evolution (LTE) RAN, etc. The communication system 100 may utilize a constellation of space vehicles (SVs) 190 which may support a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). In some embodiments, a UE 105 may communicate via an SV 190 and an Earth station (not shown in FIG. 1) with a RAN node (e.g. a gNB 110) or a 5GC 140 node, in which case the UE 105 may not communicate directly with a RAN node but only via the SV 190. This may be used to increase the coverage and/or the capacity of the NG-RAN 135. Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125, a User Plane Function (UPF) 118, and a Secure User Plane Location (SUPL) Location Platform (SLP) 119. The gNBs 110a, 110b and the ng-eNB 114 are communicatively coupled to each other, are each configured wirelessly to communicate bi-directionally with the UEs 105, and are each communicatively coupled to, and configured to bi-directionally communicate with, the AMF 115 and the UPF 118. The gNBs 110a, 110b, and the ng-eNB 114 may be referred to as base stations (BSs) or RAN nodes. The AMF 115, the SMF 117, the LMF 120, and the GMLC 125 are communicatively coupled to each other, and the GMLC 125 is communicatively coupled to an external client 130. The AMF 115, the SMF 117, the UPF 118, and the SLP 119 are communicatively coupled to each other, and the SLP 119 is communicatively coupled to the external client 130. Server 121, the Internet 122, and server 123 may be communicatively coupled with the UPF 118 and may facilitate SL positioning, according to some embodiments. The SMF 117 may further serve as an initial contact point of a Service Control Function (SCF) (not shown) to create, control, and delete media sessions. The base stations 110a, 110b, 114 may be a macro cell (e.g., a high-power cellular base station), or a small cell (e.g., a low-power cellular base station), or an access point (e.g., a short-range base station configured to communicate with short-range technology such as WI-FI, WI-FI DIRECT (Wi-Fi D), BLUETOOTH, Bluetooth-Low Energy (BLE), ZIGBEE, etc. One or more of the base stations 110a, 110b, 114 may be configured to communicate with the UEs 105 via multiple carriers. Each of the base stations 110a, 110b, 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted, as necessary. Specifically, although only UEs 105 are illustrated, many UEs (e.g., hundreds, thousands, millions, etc.) may be utilized in the communication system 100. Similarly, the communication system 100 may include a larger (or smaller) number of SVs (i.e., more or fewer than the four SVs 190 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network. Similar network implementations and configurations may be used for other communication technologies, such as 3G, Long Term Evolution (LTE), future 6G, etc. Implementations described herein (be they for 5G technology and/or for one or more other communication technologies and/or protocols) may be used to transmit (or broadcast) directional synchronization signals, receive and measure directional signals at UEs (e.g., the UEs 105) or at base stations 110a, 110b, 114 and/or provide location assistance to the UEs 105 (via the LMF 120 or SLP 119 or other location server) and/or compute a location for one or both of the UEs 105 at a location-capable device such as the UEs 105, the base stations 110a, 110b, the LMF 120, or SLP 119 based on measurement quantities received at the UEs 105 or the base stations 110a, 110b, 114 for such directionally-transmitted signals. The GMLC 125, the LMF 120, the AMF 115, the SMF 117, the UPF 118, the SLP 119, the ng-eNB (eNodeB) 114 and the gNBs (gNodeBs) 110a, 110b are examples and may, in various embodiments, be replaced by or include various other entities, including location server functionality and/or base station functionality.

The communication system 100 is capable of wireless communication in that components of the system 100 can communicate with one another (at least sometimes using wireless connections) directly or indirectly, e.g., via the base stations 110a, 110b, 114 and/or the network 140 (and/or one or more other devices not shown, such as one or more other base transceiver stations). For indirect communications, the communications may be altered during transmission from one entity to another, e.g., to alter header information of data packets, to change format, etc. The UEs 105 may include multiple UEs and may be a mobile wireless communication device but may communicate wirelessly and via wired connections. The UEs 105 may be any of a variety of devices, e.g., a smartphone, a tablet computer, a vehicle-based device, etc., but these are examples only as the UEs 105 is not required to be any of these configurations, and other configurations of UEs may be used. Other UEs may include wearable devices (e.g., smart watches, smart jewelry, smart glasses, or headsets, etc.). Still other UEs may be used, whether currently existing or developed in the future. Further, other wireless devices (whether mobile or not) may be implemented within the system 100 and may communicate with each other and/or with the UEs 105, the base stations 110a, 110b, 114, the core network 140, and/or the external client 130. For example, such other devices may include IoT or IIoT devices, medical devices, home entertainment and/or automation devices, etc. The core network 140 may communicate with the external client 130, the server 123 or the server 121 (e.g., which may each be a computer system), e.g., to allow the external client 130, the server 123 or the server 121 to request and/or receive location information regarding the UEs 105 (e.g., via the GMLC 125, SLP 119 or UPF 118).

The UEs 105 or other devices may be configured to communicate in various networks and/or for various purposes and/or using various technologies (e.g., 5G, Wi-Fi (also referred to as WiFi) communication, multiple frequencies of Wi-Fi communication, satellite positioning, satellite communication, one or more types of communications (e.g., GSM (Global System for Mobiles), CDMA (Code Division Multiple Access), LTE (Long-Term Evolution), V2X (e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or Wi-Fi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105 may communicate with each other through UE-to-UE sidelink (SL) communications by transmitting over one or more sidelink channels, such as a physical sidelink synchronization channel (PSSCH), a physical sidelink broadcast channel (PSBCH), a physical sidelink control channel (PSCCH), Synchronization Signal Block (SSB), sidelink channel state information reference signal (SL-CSIRS), physical sidelink feedback channel (PSFCH), sidelink positioning reference signals (SL PRS) or sidelink sounding reference signals (SL-SRS).

The UEs 105 may comprise and/or may be referred to as a device, a mobile device, a wireless device, a mobile terminal, a terminal, a mobile station (MS), a Secure User Plane Location (SUPL) Enabled Terminal (SET), or by some other name. Typically, though not necessarily, the UEs 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 Wi-Fi (also referred to as WiFi), Bluetooth (BT), Worldwide Interoperability for Microwave Access (WiMAX), 5G new radio (NR) (e.g., using the NG-RAN 135 and the 5GC 140), future 6G, etc. The UEs 105 may support wireless communication using a Wireless Local Area Network (WLAN) which may connect to other networks (e.g., the Internet) using a Digital Subscriber Line (DSL) or packet cable, for example. The use of one or more of these RATs may allow the UEs 105 to communicate with the external client 130, the server 121 and/or the server 123 (e.g., via elements of the 5GC 140 and possibly the Internet 122) and/or allow the external client 130, the server 121 and/or the server 123 to receive location related information regarding the UEs 105 (e.g., via the GMLC 125, SLP 119 or UPF 118).

Each of the UEs 105 may include a single entity or may include multiple entities such as in a personal area network where a user may employ audio, video and/or data I/O (input/output) devices and/or body sensors and a separate wireline or wireless modem. An estimate of a location of a UE, e.g., UE 105, may be referred to as a location, location estimate, location fix, fix, position, position estimate, or position fix, and may be geodetic, thus providing location coordinates for the UE (e.g., latitude and longitude) which may or may not include an altitude component (e.g., height above sea level, height above or depth below ground level, floor level, or basement level). Alternatively, a location of the UE may be expressed as a civic location (e.g., as a postal address or the designation of some point or small area in a building such as a particular room or floor). A location of the UE may be expressed as an area or volume (defined either geodetically or in civic form) within which the UE is expected to be located with some probability or confidence level (e.g., 67%, 95%, etc.). A location of the UE may be expressed as a relative location comprising, for example, a distance and direction from a known location. The relative location may be expressed as relative coordinates (e.g., X, Y (and Z) coordinates) defined relative to some origin at a known location which may be defined, e.g., geodetically, in civic terms, or by reference to a point, area, or volume, e.g., indicated on a map, floor plan, or building plan. In the description contained herein, the use of the term location may comprise any of these variants unless indicated otherwise.

When sidelink positioning is used, an absolute (e.g. global) or relative location of a UE may not always be obtained. Instead, location results may be obtained for a UE which may include a range or distance between the UE and each of one or more other UEs, a direction from the UE to each of one or more other UEs, a location of the UE relative to the location of some other UE, a location of one or more other UEs relative to the location of the UE, a velocity of the UE, and/or a velocity of each of one or more other UEs. A velocity of a UE may be absolute (e.g. relative to the Earth) or may be relative to some other UE, and may then be referred to as a “relative velocity”. A relative velocity of a UE B relative to another UE A may include a “radial velocity” component, which may be equal to a rate of change of a range from the UE A to the UE B, and a “transverse velocity” component which may be at right angles to the radial velocity component as seen by the UE A and may be equal to a rate of angular change of a direction to the UE B from the UE A multiplied by the range from the UE A to the UE B. In the description contained herein, the use of the term “location result” or “location results” for sidelink positioning of a UE or a group of UEs may comprise any of these variants unless indicated otherwise.

The term “target UE” as used herein may refer to a UE for which location results are desired. When a group of two or more UEs participate in SL positioning, only some of the group of UEs may be target UEs as location results may already be known or may not be needed for the other UEs. However, for generality, when discussing the techniques described herein for positioning of a group of UEs, all of the UEs can be considered to be potentially target UEs, as there may be little or no difference in how the techniques described herein are used for the positioning.

The UEs 105 may be configured to communicate with other entities using one or more of a variety of technologies. The UEs 105 may be configured to communicate with one or more other UEs (e.g. other UEs 105) via one or more device-to-device (D2D) peer-to-peer (P2P) links. The D2D P2P links may be an example of (or may be supported by) sidelink signaling and be supported with any appropriate D2D radio access technology (RAT), such as LTE Direct (LTE-D), Wi-Fi Direct (Wi-Fi D), Bluetooth, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas or be otherwise unable to receive transmissions from a base station. Groups of UEs communicating via D2D communications may utilize a one-to-many (1: M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UEs 105 via wireless communication between the UEs and one or more of the gNBs 110a, 110b, which may provide wireless communications access to the 5GC 140 on behalf of the UE using 5G. In FIG. 1, the serving gNB for the UE 105A is assumed to be the gNB 110b, while the serving gNB for the UE 105B is assumed to be the gNB 110a, although another gNB may act as a serving gNB if the UEs 105 move to another location or may act as a secondary gNB to provide additional throughput and bandwidth to the UEs 105 and the UEs 105 may share the same serving gNB.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UEs 105. One or more of the gNBs 110a, 110b and/or the ng-eNB 114 may be configured to function as positioning-only beacons which may transmit signals to assist with determining the position of the UEs 105 but may not receive signals from the UEs 105 or from other UEs.

The base stations 110a, 110b, 114 may transmit one or more downlink reference signals, including a positioning reference signal (PRS) transmission. The PRS transmission may be configured for a specific UEs 105 to measure and report one or more report parameters (for example, report quantities) associated with positioning and location information. The PRS transmission and report parameter feedback may support various location services (for example, navigation systems and emergency communications). In some examples, the report parameters supplement one or more additional location systems supported by the UE 105 (such as global positioning system (GPS) technology).

A base station 110a, 110b, 114 may configure a PRS transmission on one or more PRS resources of a channel. A PRS resource may span resource elements of multiple physical resource blocks (PRBs) within one or more OFDM symbols of a slot depending on a configured number of ports. For example, a PRS resource may span one symbol of a slot and contain one port for transmission. In any OFDM symbol, the PRS resources may occupy consecutive PRBs. In some examples, the PRS transmission may be mapped to consecutive OFDM symbols of the slot. In other examples, the PRS transmission may be mapped to interspersed OFDM symbols of the slot. Additionally, the PRS transmission may support frequency hopping within PRBs of the channel.

The one or more PRS resources may span a number of PRS resource sets according to a PRS resource setting of the base station 110a, 110b, 114. The structure of the one or more PRS resources, PRS resource sets, and PRS resource settings within a PRS transmission may be referred to as a multi-level resource setting. For example, multi-level PRS resource setting of the base station 110a, 110b, 114 may include multiple PRS resource sets and each PRS resource set may contain a set of PRS resources (such as a set of 4 PRS resources).

The UEs 105 may receive the PRS transmission over the one or more PRS resources of the slot. The UEs 105 may determine a report parameter for at least some PRS resources included in the transmission. The report parameter (which may include a report quantity) for each PRS resource may include one or more of a time of arrival (TOA), a reference signal time difference (RSTD), a reference signal receive power (RSRP), an angle, a PRS identification number, a reception to transmission difference (UE Rx-Tx), a signal-to-noise ratio (SNR), or a reference signal receive quality (RSRQ).

Similarly, the UEs 105 may be configured to transmit one or more additional uplink reference signals that may be received by base stations 110a, 110b, 114 and used for positioning. For example, UEs 105 may transmit sounding reference signal (SRS) for positioning. Base stations 110a, 110b, 114 that receive uplink reference signals from a UEs 105 may perform positioning measurements, such as one or more of a time of arrival (TOA), reception to transmission difference (UE Rx-Tx).

A position estimation of the UE may be determined using reference signals, such as PRS signals or SRS for positioning signals, or other reference signals, from one or more base stations 110a, 110b, 114 or the UE. Positioning methods, such as downlink (DL) Time Difference of Arrival (DL-TDOA), DL Angle of Departure (DL AOD), Enhanced Cell ID (ECID) are position methods that may be used to estimate the position of the UE using reference signals from base stations. DL-TDOA, for example, relies on measuring Reference Signal Time Differences (RSTDs) between downlink (DL) signals received from a base station for a reference cell and base station(s) for one or more neighbor cells. The DL signals for which RTSDs may be obtained comprise a Cell-specific Reference Signal (CRS) and a Positioning Reference Signal (PRS).

Other positioning methods may use reference signals transmitted by the UE including uplink-based positioning methods and downlink and uplink based positioning methods. For example, uplink-based positioning methods include, e.g., UL Time Difference of Arrival (UL-TDOA), UL Angle of Arrival (UL AOA), UL Relative Time of Arrival (UL-RTOA). Downlink and uplink based positioning methods include, e.g., multi cell Round-trip time (RTT) between a UE and one or more neighboring base stations. Additionally, sidelink based positioning may be used in which UEs transmit and/or receive sidelink positioning reference signals that are measured and used for positioning.

As noted, while FIG. 1 depicts nodes configured to communicate according to 5G communication protocols, nodes configured to communicate according to other communication protocols, such as, for example, an LTE protocol, a IEEE 802.11x protocol, or a future 6G protocol, may be used. For example, in an Evolved Packet System (EPS) providing LTE wireless access to the UEs 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UEs 105, including cell change and handover and may participate in supporting a signaling connection to the UEs 105 and possibly data and voice bearers for the UEs 105. The LMF 120 may communicate directly or indirectly with the UEs 105, e.g., through wireless communications, or directly or indirectly with the base stations 110a, 110b, 114. The LMF 120 may support positioning of the UEs 105 when the UEs 105 access the NG-RAN 135 and may support position procedures/methods such as Assisted GNSS (A-GNSS), Time Difference of Arrival (TDOA) (e.g., Downlink (DL) TDOA or Uplink (UL) TDOA), Real Time Kinematic (RTK), Precise Point Positioning (PPP), Differential GNSS (DGNSS), Enhanced Cell ID (E-CID), angle of arrival (AOA), angle of departure (AOD), and/or other position methods. The LMF 120 may process location services requests for the UEs 105, e.g., received from the AMF 115 or from the GMLC 125. The LMF 120 may be connected to the AMF 115 and/or to the GMLC 125. A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE) may be performed at the UE (e.g., using signal measurements obtained by the UE for signals transmitted by wireless nodes such as the gNBs 110a, 110b and/or the ng-eNB 114, and/or assistance data provided to the UE, e.g., by the LMF 120). At least part of the positioning functionality (including derivation of the location of the UE) alternatively may be performed at the LMF 120 (e.g., using signal measurements obtained by the gNBs 110a, 110b and/or the ng-eNB 114. The AMF 115 may serve as a control node that processes signaling between the UEs 105 and the core network 140, and provides QoS (Quality of Service) flow and session management. The AMF 115 may support mobility of the UEs 105 including cell change and handover and may participate in supporting signaling connection to the UEs 105.

The GMLC 125 may support a location request for the UEs 105 received from the external client 130 and may forward such a location request to the AMF 115 for forwarding by the AMF 115 to the LMF 120 or may forward the location request directly to the LMF 120. A location response from the LMF 120 (e.g., containing a location estimate or sidelink location results for the UEs 105) may be returned to the GMLC 125 either directly or via the AMF 115 and the GMLC 125 may then return the location response (e.g., containing the location estimate or sidelink location results) to the external client 130. The GMLC 125 is shown connected to both the AMF 115 and LMF 120, though only one of these connections may be supported by the 5GC 140 in some implementations.

A User Plane Function (UPF) 118 may support voice and data bearers for UE 105 and may enable UE 105 voice and data access to other networks such as the Internet 122 and to servers such as server 121 and server 123. The UPF 118 may be connected to gNBs 110 and ng-eNB 114. UPF 118 functions may include: external Protocol Data Unit (PDU) session point of interconnect to a Data Network, packet (e.g. Internet Protocol (IP)) routing and forwarding, packet inspection and user plane part of policy rule enforcement, Quality of Service (QoS) handling for user plane, downlink packet buffering and downlink data notification triggering. UPF 118 may be connected to the SLP 119 to enable support of positioning of UE 105 using SUPL. SLP 119 may be further connected to or accessible from external client 130.

As illustrated, a Session Management Function (SMF) 117 connects to the AMF 115 and the UPF 118. The SMF 117 may have the capability to control both a local and a central UPF within a PDU session. SMF 117 may manage the establishment, modification, and release of PDU sessions for UE 105, perform IP address allocation and management for UE 105, act as a Dynamic Host Configuration Protocol (DHCP) server for UE 105, and select and control a UPF 118 on behalf of UE 105.

As further illustrated in FIG. 1, the LMF 120 may communicate with the gNBs 110a, 110b and/or the ng-eNB 114 using a New Radio Position Protocol A (NRPPa), which may be defined in 3GPP Technical Specification (TS) 38.455. NRPPa messages may be transferred between the gNB 110a (or the gNB 110b) and the LMF 120, and/or between the ng-eNB 114 and the LMF 120, via the AMF 115. As further illustrated in FIG. 1, the LMF 120 and the UEs 105 may communicate using an LTE Positioning Protocol (LPP), which may be defined in 3GPP TS 37.355. Here, LPP messages may be transferred between the UEs 105 and the LMF 120 via the AMF 115 and the serving gNB 110a, 110b or the serving ng-eNB 114 for the UEs 105. For example, LPP messages may be transferred between the LMF 120 and the AMF 115 using service operations based on the Hypertext Transfer Protocol (HTTP) and may be transferred between the AMF 115 and the UEs 105 using a 5G Non-Access Stratum (NAS) protocol.

The LPP protocol may be used to support positioning of the UEs 105 using UE-assisted and/or UE-based position methods such as A-GNSS, RTK, TDOA, AOA, AOD, and/or E-CID. The NRPPa protocol may be used to support positioning of the UEs 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional Synchronization Signal (SS) transmissions from the gNBs 110a, 110b, and/or the ng-eNB 114. The LMF 120 is illustrated in FIG. 1 as being located in the core network 140, but may be external to the core network 140, e.g., in an NG-RAN. For example, the LMF 120 may be co-located or integrated with a gNB, or may be disposed remote from the gNB and configured to communicate directly or indirectly with the gNB.

With a UE-assisted position method, the UE, e.g., UE 105A or UE 105B may obtain location measurements and send the measurements to a location server (e.g., the LMF 120) for computation of a location estimate for the UE. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ), AOA, AOD, for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE, e.g., UE 105A or UE 105B, may obtain location measurements (e.g., which may be the same as or similar to location measurements for a UE-assisted position method) and may compute a location of the UE (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114), may obtain location measurements (e.g., measurements of RSSI, RTT, RSRP, RSRQ, AOA, AOD, or Time of Arrival (ToA) for signals transmitted by the UE, e.g., UE 105A or UE 105B) and/or may receive measurements obtained by the UE. The one or more base stations or APs may send the measurements to a location server (e.g., the LMF 120) for computation of a location estimate for the UE.

As noted, while the communication system 100 is described in relation to 5G technology, the communication system 100 may be implemented to support other communication technologies, such as GSM, WCDMA, LTE, etc., that are used for supporting and interacting with mobile devices such as the UEs 105 (e.g., to implement voice, data, positioning, and other functionalities). For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125.

Positioning for UEs in a radio network, such as communication system 100 shown in FIG. 1, typically uses Uu interfaces, i.e., a radio interface between a UE 105 and the radio access network, for DL PRS and/or UL PRS. Positioning for UEs may also or instead use sidelink PRS (SL PRS), which may be a specific sidelink defined reference signal for positioning or may reuse Uu PRS, e.g., UL PRS, sometimes referred to as Sounding Reference Signal for positioning (SRSPos), or other reference signals may be transmitted in the sidelink channel. Sidelink positioning may enhance UE positioning by providing additional transmission (or reception) nodes. A UE, such as UE 105B, with a known position may be used to support position determination of another target UE, such as UE 105A, where the UE 105B is sometimes referred to as an anchor node.

With a sidelink positioning method, a UE 105A for example may transmit a sidelink PRS or sidelink SRS signal which is received and measured by another UE 105B. In addition or instead, the UE 105B for example may transmit a sidelink PRS or sidelink SRS signal which is received and measured by the UE 105A. A sidelink PRS may be similar to a PRS (e.g. DL PRS) transmitted by a gNB 110, e.g. as described previously. A sidelink SRS may be similar to an SRS (e.g. uplink) SRS transmitted by a UE 105 for measurement by a gNB 110, e.g. as described previously. SL PRS may be transmitted over separate short periods (e.g. of around 1 millisecond in duration) referred at as “SL PRS occasions” or as “SL PRS positioning occasions”. Measurements of SL PRS or SL SRS signals may include a reception to transmission time difference (Rx-Tx), time of arrival (TOA), reference signal receive power (RSRP), reference signal receive quality (RSRQ), angle of arrival (AOA) and reference signal time difference (RSTD). SL position methods may include SL round trip signal propagation time (RTT) (also referred to as ranging), SL AOA and SL AOD.

In some scenarios, a group of UEs 105 may support SL positioning. In this case, one UE in the group (e.g. UE 105A) may transmit an SL PRS or SL SRS signal which may be measured by some or all of the other UEs 105 in the group (e.g. UEs 105B and 105C). Some or all of the other UEs 105 in the group may also each transmit an SL PRS or SL SRS signal (e.g. with each UE 105 transmitting SL SRS or SL PRS at a different time or times than times at which other UEs 105 in the group transmit SL PRS or SL SRS) which may be measured by some or all other UEs 105 in the group different to the UE 105 transmitting the UL PRS or ULS SRS. Measurements made by UEs 105 applicable to transmission of SL PRS or SL SRS by a group of UEs 105 may include Rx-Tx, TOA, RSTD, AOA, RSRP, RSRQ. Position methods supported by these measurements may include sidelink RTT (e.g. ranging), sidelink AOA, sidelink AOD, sidelink TDOA (SL-TDOA). Based on the measurements and the position methods(s), each UE 105 may determine location results for itself and/or for one or more other UEs 105 in the group. As described previously, the location results for a UE 105 may include a range or distance between the UE 105 and each of one or more other UEs 105 in the group, a direction from the UE 105 to each of one or more other UEs 105 in the group, a direction to the UE 105 from each of one or more other UEs 105 in the group, a location of the UE 105 relative to a location of some other UE 105 in the group, a location of the UE 105 relative to some other known location, an absolute location of the UE 105, a velocity of the UE 105 or a velocity of the UE 105 relative to some other UE 105.

Sidelink positioning may be used for positioning of UEs independently of a core network (e.g. 5GC 140) or a serving PLMN. One example implementation of sidelink positioning may be found in vehicular communication systems, such as V2X, which may be used for safety related applications, such as safety warnings, traffic congestion (e.g., automated traffic control), and coordinated or automated vehicle maneuvering. One aspect of sidelink positioning that may require a solution for standardization is a sidelink positioning protocol (SLPP) that can be used between UEs, including between an RSU and UEs, and location servers. The SLPP, for example, may support sidelink positioning between UEs, RSUs, and PRUs with network access independence. The SLPP may provide support for sidelink positioning for a pair of UEs (e.g., ranging), groups of UEs (V2X), and for UEs that are members of multiple different groups. By way of example, SLPP may provide support for various position techniques currently standardized for UE-based and UE-assisted support by a location server (e.g. LMF 120) such as PRS RTT, AOA, Differential AOA (DAOA), AOD, Differential AOD (DAOD), but may also enable the support of other PRS and SRS based position methods and non-PRS methods such as RTK at a later time. By enabling the addition of new capabilities and methods at a later time, the SLPP may avoid the need to define separate new positioning protocols different to SLPP. By way of example, additional position methods that may be included in SLPP at a later time may include RTK, Wi-Fi, Ultra-Wideband (UWB), BT positioning methods.

The SLPP may enable direct sidelink operation initially (where UEs communicate and coordinate positioning by exchanging SLPP messages using sidelink signaling), and may be extended later to sidelink operation via relays and operation via a network, where UEs may exchange SLPP messages via a network or via intermediate relay UEs. For example, this might be used to coordinate positioning of two vehicles on a collision course at a corner where direct SL signaling between the two vehicles is not possible. Thus, SLPP may define support for SL PRS based positioning initially in a generic manner to simplify extension to support of other position methods later. For example, SLPP may define generic SLPP messages similar to generic LPP messages defined for LPP in 3GPP TS 37.355. SLPP may support separate position methods (e.g. SL PRS RTT, SL PRS AOA, SL PRS AOD) using common procedures and common parameters where feasible. SLPP may define procedures that can be reused for multiple position methods and are not limited to just one or a few position methods. SLPP may be enabled to be transferred and used by various entities, such as UEs, RSUs, PRUs, and location servers, such as LMFs and SUPL SLPs. The location server (e.g., LMF and SUPL SLP) usage may transfer SLPP messages inside LPP messages to enable UE-assisted positioning by an LMF or SUPL SLP. Alternatively, the location server (e.g., LMF and SUPL SLP) usage may transfer SLPP messages not in association with LPP messages to enable UE-assisted positioning by an LMF or SUPL SLP. SLPP may further support relative (local) and global positioning.

FIG. 2, by way of example, shows an architecture of a communication system 200 capable of network-supported sidelink positioning. As illustrated in FIG. 2, a number of UEs may be combined within a same group 210 for sidelink positioning. Within the group 210, various subgroups of UEs may be present. For example, the group 210 of UEs may include a first subgroup 212 of UEs that is served by a first network (PLMN1 140a), while a second subgroup 214 of UEs is served by a second (different) network (PLMN2 140b), and a third subgroup 216 of UEs is out of coverage of and is not served by either network. One or more of the UEs served by a network, e.g., the UEs in subgroup 212 served by PLMN1 140a, or the UEs in subgroup 214 served by PLMN2 140b, may include RSUs.

A location server in a serving network, e.g., LMF1 120a, SUPL SLP1 119a, or Server1 121a in the serving PLMN1 140a, LMF2 120b, SUPL SLP2 119b, or Server2 121b in the serving PLMN2 140b, and Server3 123 (communicating to UEs via PLMN1 140a and/or PLMN2 140b), may assist some or all UEs in a group that are served by the network (PLMN), e.g., subgroups 212 and 214, respectively. As illustrated, the location servers may support UEs by communicating with the UEs using “LPP/SLPP,” which represents communicating using LPP, SLPP, embedding SLPP in LPP, or a combination thereof. For example, LMF1 120a and LMF2 120b may embed SLPP in LPP while supporting UEs in subgroups 212 and 214, respectively (e.g. where each SLPP message transferred between a UE and LMF1 120a or LMF2 120b is embedded in one LPP message and where one LPP message may include one or more than one embedded SLPP messages). Similarly, SUPL SLP1 119a and SUPL SLP2 119b may embed SLPP in LPP with LPP messages embedded in SUPL UserPlane Location Protocol (ULP) messages while supporting UEs in subgroups 212 and 214, respectively. Additionally or alternatively, LPP messages and/or SLPP messages may be used, where SLPP messages are not embedded in LPP messages (though LPP messages or SLPP messages may still be embedded in SUPL ULP messages). Additionally, the UEs within each subgroup, and UEs in different subgroups may exchange SLPP messages with one another to support and coordinate SL positioning.

The location server (e.g., LMF/SUPL SLP/Server 1/Server2/Server3) support for a particular UE or UEs may not be visible to other UEs in the group. For example, the location server support from the PLMN1 140a for UEs in subgroup 212 may not be visible to UEs in subgroup 214 and may not be visible to the out of coverage UEs in subgroup 216. The support provided by location servers to the UEs may include determination or verification of SL PRS configurations and calculation of location results for UEs, including for UEs that are supported and for UEs that are not supported (e.g. such as calculating location results for UEs within a supported subgroup and for UEs within an unsupported subgroup, e.g. if position information for the UEs in the unsupported subgroup is provided to the location server). In some implementations, signaling between location servers in separate networks may be used to provide more complete network support. As illustrated, LMF-LMF or SUPL SLP-SUPL SLP signaling may use an extension of SLPP (referred to as SLPP** in FIG. 2) to enable more complete network support.

The SLPP message types may align with LPP message types to enable LPP messages to contain embedded SLPP messages and/or to enable SLPP procedures to align with LPP procedures which may reduce implementation and/or testing. FIG. 2 shows signaling (e.g. SLPP messages or SLPP messages embedded in LPP messages) between LMF1 120a and one or more of the UEs of subgroup 212 and signaling between LMF2 120b and one or more of the UEs of subgroup 214. FIG. 2 also shows SLPP messages, or LPP messages that contain embedded SLPP messages, and that are embedded in SUPL ULP messages that are exchanged between SUPL SLP1 119a and one or more of the UEs of subgroup 212 and between SUPL SLP2 119b and one or more of the UEs of subgroup 214. SLPP may include messages that are analogous to an LPP Request Capabilities message and an LPP Provide Capabilities message, which, for example, in SLPP may be called “Request Capabilities and Resources” and “Provide Capabilities and Resources”. The Request/Provide Capabilities and Resources in SLPP may be restricted to NR SL PRS capabilities and resources initially, but may be extended later to capabilities and resources for LTE SL PRS, RTK, Wi-Fi, BT, etc.

In another example, SLPP may include a message that is analogous to an LPP Provide Assistance Data message, which, for example, in SLPP may be called a “Provide Positioning Signal Configuration” (or just a “Provide Assistance Data”). The Provide Positioning Signal Configuration in SLPP may include one or more of, e.g., the SL PRS Configuration to be transmitted by each UE and measured by other UEs, a start time and duration of the transmission, and conditions for termination of the transmission, and the types of SL PRS measurements requested, such as Rx-Tx, AOA, RSRP, RSRD, TOA, TDOA. In some implementations, the Provide Positioning Signal Configuration in SLPP may be extended to define other types of signals, such as RTK signals to be measured, Wi-Fi signal to be transmitted and measured etc. The Provide Positioning Signal Configuration in SLPP may include additional information, for example, to assist UEs in acquiring and measuring signals (e.g. SL PRS signals) and to determine times of transmission and measurement.

In another example, SLPP may include a message such as a “Confirm Positioning Signal Configuration” (or a “Provide Assistance Data Confirm”), which does not have an analogous LPP message. The Confirm Positioning Signal Configuration in SLPP, for example, may confirm whether a Provide Positioning Signal Configuration (or a Provide Assistance Data) is agreeable. If the Provide Positioning Signal Configuration is (partly) not agreeable, a different configuration may be provided as a Provide Positioning Signal Configuration. Because LPP does not have an analogous message, a new LPP message type may be added to carry the Confirm Positioning Signal Configuration SLPP message in the case that SLPP messages are embedded in LPP messages. However, such a new LPP message type may not be needed when SLPP messages are not embedded in LPP messages.

In another example, SLPP may include a message that is analogous to an LPP Provide Location Information message, which, for example, in SLPP may be called a “Provide Location Information” message. The Provide Location Information message in SLPP may include and provide SL PRS measurements obtained by a UE for SL PRS transmitted by one or more other UEs and/or may include and provide location results obtained for the UE and/or for other UEs. The Provide Location Information in SLPP may be extended to include and provide other measurements, such as measurements of RTK, Wi-Fi, BT etc.

As illustrated in FIG. 2, UEs within each subgroup and UEs in different subgroups may signal each other using SLPP (e.g. where a UE sends an SLPP message to one or more other UEs). Additionally, location servers (e.g., LMF, SUPL SLP, or Server1-3) may support UEs using SLPP (as discussed above). As previously noted, SLPP may be embedded in LPP or embedded in both LPP and SUPL, or may be sent without embedding in LPP according to some embodiments. Accordingly, a first UE may receive a first SLPP message from a second UE and may send the first SLPP message to a location server that supports the first UE. The first UE may receive a second SLPP message from the location server in response to the first SLPP message and may send the second SLPP message to the second UE.

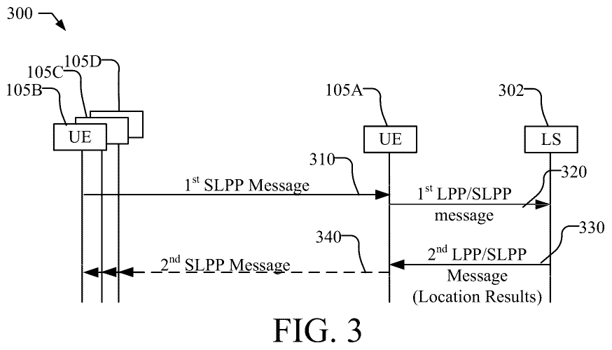

FIG. 3, by way of example, is a signal flow 300 illustrating the signaling between a UE 105A and UEs 105B, 105C, and 105D and a location server 302 for network supported sidelink positioning, as discussed herein. The UEs 105A, 105B, 105C, and 105D, may belong to the same group, and may be, e.g., the UEs 105 illustrated in FIG. 1 or any of the UEs illustrated within network supported subgroups 212 and 214 in FIG. 2. The location server 302 may be any of the LMF 120, SUPL SLP 119, Server 121, or Server 123 shown in FIG. 1 or the LMF1 120a or SUPL SLP1 119a shown in FIG. 2.

As shown in FIG. 3, at 310, the UE 105A receives a first sidelink positioning message from the UE 105B. The first sidelink positioning message, for example, may be an SLPP message, as discussed above, and may be any of the message types discussed above. The first sidelink positioning message may be sent based on SL multicasting (also referred to as SL groupcasting) if the group contains more than two UEs, e.g., as illustrated in FIG. 3, or may be sent based on SL unicasting. With SL multicasting (also referred to as SL groupcasting), a sidelink positioning message (e.g. an SLPP message) may be transmitted containing a group destination address (e.g. which may be partly or completely included in a layer 1 protocol header and/or in a layer 2 protocol header in the sidelink positioning message). A recipient UE (e.g. UE 105A) that belongs to a group which has this group destination address then recognizes the group destination address in the sidelink positioning message and receives, decodes and processes the sidelink positioning message. With SL unicasting, the sidelink positioning message may be transmitted containing a UE destination address (e.g. a layer 2 address assigned to UE 105A) and is received, decoded and processed only by the UE (e.g. UE 105A) whose destination address is included.

In 320, the UE 105A sends a first LPP/SLPP message (e.g., a first SLPP message or the first SLPP message embedded in an LPP message, as previously noted) to the location server 302, where the first SLPP message is based on or comprises the first sidelink positioning message.

In 330, the UE 105A receives a second LPP/SLPP message from the location server 302 in response to the first LPP/SLPP message from 320. The second LPP/SLPP message may be a second SLPP message or the second SLPP message embedded in an LPP message, as discussed above, and may be any of the message types discussed above. The second LPP/SLPP message (e.g. the second SLPP message) may include location results for at least one UE in the group (e.g. UE 105A or UE 105B). For example, location results for at least one UE in the group may comprise at least one of a range between the at least one UE and another UE, a direction from the at least one UE to another UE, a location of the at least one UE relative to the location of another UE, a velocity of the at least one UE, a relative velocity of the at least one UE relative to the velocity of another UE, or some combination of these.

In 340, the UE 105A may send a second sidelink positioning message to one or more of the UEs 105B, 105C, and 105D in the group. The second sidelink positioning message may be an SLPP message and may be based on or may comprise the second SLPP message received at 330. The second sidelink positioning message may be sent based on SL multicasting if the group contains more than two UEs, e.g., as illustrated in FIG. 3.

The sidelink positioning messages in signal flow 300 may be any of the message types as discussed above. For example, the first sidelink positioning message at 310 and the first LPP/SLPP message at 320 may include sidelink positioning capabilities, sidelink positioning resources or both for at least one UE in the group, e.g., UE 105B. The first LPP/SLPP message at 320 may include an LPP Provide Capabilities message and/or an SLPP Provide Capabilities message (e.g. where the SLPP Provide Capabilities message may be embedded in the LPP Provide Capabilities message). The second LPP/SLPP message at 330 and the second sidelink positioning message at 340 may include sidelink positioning capabilities, sidelink positioning resources or both for the UE 105A. The second LPP/SLPP message at 330 may include an LPP Provide Capabilities message and/or an SLPP Provide Capabilities message.

In another example, the first sidelink positioning message at 310 and the first LPP/SLPP message at 320 may include an SL Positioning Reference Signal (PRS) configuration for at least one UE in the group, e.g., UE 105A and/or UE 105B. The first LPP/SLPP message at 320 may include an LPP Request Assistance Data message, an LPP Provide Assistance Data message, an SLPP Request Assistance Data message and/or an SLPP Provide Assistance Data message (e.g. where an SLPP message may be embedded in an LPP message of the same type). The second LPP/SLPP message at 330 and the second sidelink positioning message at 340 may include an SL Positioning Reference Signal (PRS) configuration for at least one UE in the group, e.g., UE 105A or UE 105B. The second LPP/SLPP message at 330 may include an LPP Provide Assistance Data message and/or an SLPP Provide Assistance Data message (e.g. where the SLPP Provide Assistance Data message may be embedded in the LPP Provide Assistance Data message).

In another example, the first sidelink positioning message at 310 and the first LPP/SLPP message at 320 may include sidelink positioning measurements obtained by at least one UE in the group, e.g., UE 105B. The first LPP/SLPP message at 320 may include an LPP Provide Location Information message and/or an SLPP Provide Location Information message (e.g. where the SLPP Provide Location Information message may be embedded in the LPP Provide Location Information message). The second LPP/SLPP message at 330 may include the location results for the at least one UE in the group, where the second LPP/SLPP message includes an LPP Provide Location Information message and/or an SLPP Provide Location Information message (e.g. where the SLPP Provide Location Information message may be embedded in the LPP Provide Location Information message).

The location server 302 may be an LMF or a SUPL SLP. If the location server 302 is a SUPL SLP, the first LPP/SLPP message is sent by the UE 105A to the location server 302 at 320 as part of a first SUPL message, and the second LPP/SLPP message is received by the UE 105A at 330 from the location server 302 as part of a second SUPL message. The first SUPL message and the second SUPL message may each include a SUPL POS message.

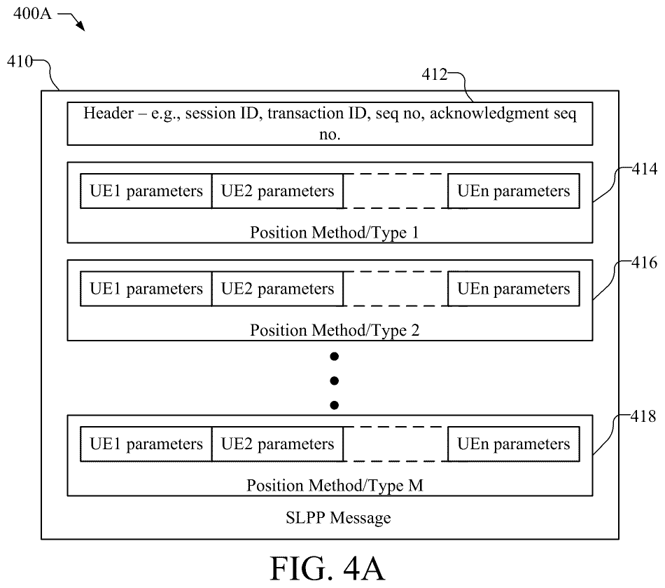

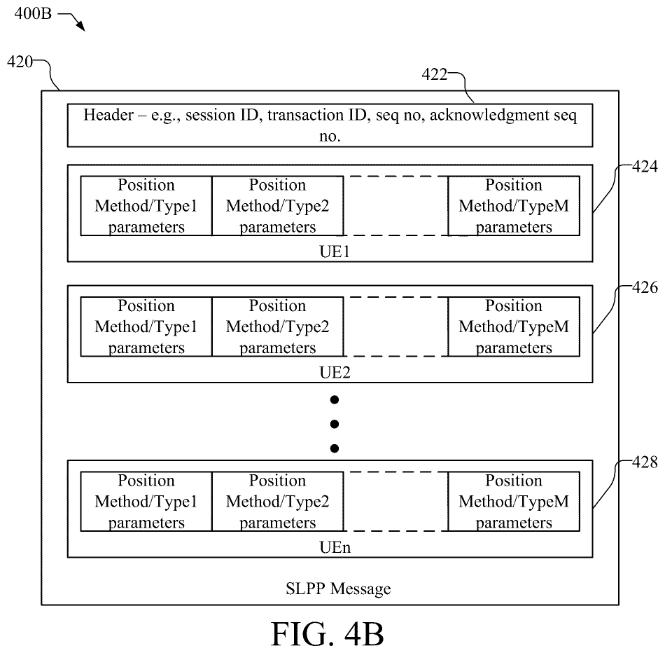

FIG. 4A, by way of example, is a block diagram 400A illustrating one implementation of the structure of an SLPP message 410. As illustrated, the SLPP message 410 includes a header 412, which may include a session ID, a transaction ID, a sequence number (seq no), an acknowledge (or acknowledgment) sequence number (acknowledgment seq no), etc. The SLPP message 410 allows for one or more position methods or position method types. For example, the SLPP message 410 includes, as entries, a position method/type 1 414, a position method/type 2 416, and a position method/type M 418 (e.g. where M could be equal to three or more). A position method, for example, may use a specific signal type or types (e.g., SL NR PRS, SL LTE PRS, Wi-Fi or GPS L1-L5) and supports one method of determining location for that specific signal type (e.g. one of RTT, AOA, RSRP or TDOA). A position method type, on the other hand, uses a specific signal type or types and supports multiple position methods for that signal type or types. For example, a position method type could use SL PRS signals (e.g. either SL NR PRS signals or both SL NR PRS and SL LTE PRS signals) and support multiple position methods that use these SL PRS signals (e.g. could support all of RTT, AOA, RSRP and TDOA). Another position method type could use GNSS signals and support multiple position methods that use GNSS signals (e.g. could support GNSS code phase based positioning and GNSS carrier phase based positioning such as RTK).

The SLPP message 410 may be configured to support position methods or position method types (also referred to as position types), or both position methods and position method types. As illustrated, each position method/type 414, 416, and 418 in the SLPP message 410 may include parameters for each UE in a group, which are illustrated as being identified by member IDs, e.g. UE1, UE2, . . . . UEn. It is possible that not all UEs in a group support the same position methods/types, which could mean that parameters for a UE not supporting a position method/type 414, 416, or 418 might not be present for that position method/type in the SLPP message 410. Support for multiple position methods or position method types in the SLPP message 410 may be advantageous when UEs do not all support the same position methods or same position method types. e.g. where some UEs may support positioning using RTK and SL PRS, while some other UEs only support RTK. In some implementations, however, the SLPP message 410 may provide support for only one position method (e.g. NR SL PRS RTT) or one position method type (e.g., NR SL PRS). FIG. 4B is a block diagram 400B illustrating another implementation of the structure of an SLPP message 420. Similar to the block diagram 400A of FIG. 4A, the SLPP message 420 includes a header 422, which may include similar information to the header 412 in FIG. 4A. Here, however, data may be structured such that each UE in a group of n UEs has a separate message portion 424, 426, and 428 in the SLPP message 420 that each include parameters for that UE for each position method/type 1-M supported by that UE.

The SLPP messages 410 and 420 shown in FIGS. 4A and 4B may include other information at other protocol levels used to transmit (and transport) the SLPP message such as a level 2 address of a UE sending or receiving the SLPP message and/or a level 2 group address for a group of UEs to which the SLPP message is sent by multicast (also referred to as groupcast).

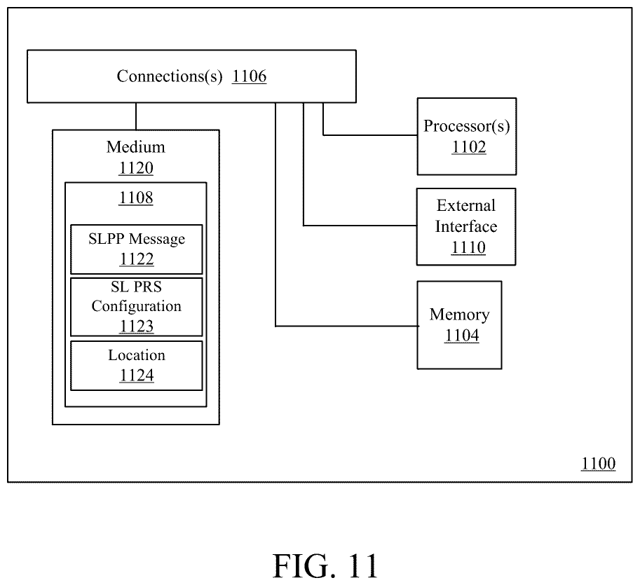

It is noted that the SLPP messages shown in FIGS. 4A and 4B may be used for positioning of UEs. SLPP messages that are not directly used for positioning of UEs but are instead used to manage SLPP sessions (e.g. to start, modify or terminate an SLPP session as described later for FIGS. 11-18) may include other parameters such as IDs and addresses for UEs participating in an SLPP session and may not include parameters for SL position methods and position method types as shown in FIGS. 4A and 4B. However, such “non-positioning” SLPP messages may still include the header 412 shown in FIGS. 4A and 4B.

FIG. 5 by way of example, is a signal flow 500 illustrating the signaling between UE 105A and UE 105B for pairwise sidelink positioning involving just two UEs. The UE 105A and UE 105B, for example, may be, e.g., the UEs illustrated in FIG. 1 or any two of the UEs illustrated in group 210 shown in FIG. 2. The sidelink positioning illustrated in FIG. 5 can be independent of a network and thus, the UEs shown in FIG. 5 may be the out-of-coverage UEs in subgroup 216. The signaling performed in signal flow 500 may be similar to or the same as the SLPP signaling discussed above in reference to FIG. 2. The signal flow 500 illustrates a simple type of SLPP session between UE 105A and UE 105B in which there may or may not be explicit session establishment and session termination.

At stage 0 of FIG. 5, the discovery of UEs and establishment of a sidelink communication session or sidelink positioning session may be performed. The discovery process may be request-response or announcement based. The discovery phase, for example, may be implemented by one or both of UEs 105A and 105B to detect other UEs that are available for sidelink positioning. For example, discovery messages may be exchanged between UE 105A and/or UE 105B to determine nearby UEs that are available to participate in sidelink positioning. For example, UE 105A may broadcast a discovery based message using sidelink signaling which UE 105B may receive and respond to by transmitting a similar discovery based response message back to UE 105A using sidelink signaling. Additional messages may be exchanged between UE 105A and UE 105B to explicitly establish a sidelink communication or positioning session between UEs 105A and 105B. For example, UE 105A may send a request (e.g. an SLPP request) to UE 105B to start an SLPP positioning session and UE 105B may return a response (e.g. an SLPP response) to UE 105A agreeing to start the SLPP positioning session.

At stage 1, the UEs 105A and 105B may exchange SLPP capabilities, resources and service requirements, which may include Quality of Service (QoS), for example, using SLPP Request Capabilities and Resources and SLPP Provide Capabilities and Resources messages as discussed above. Exchanging SLPP capabilities, resources and service requirements may include both of UE 105A and UE 105B sending their capabilities, resources and service requirements to the other UE or just one of UE 105A or UE 105B sending its capabilities, resources and service requirements to the other UE. The capabilities that are exchanged may define what each of the UEs 105A and 105B is implemented to support. The resources that are exchanged may define what capabilities each of the UEs 105A and 105B is permitted to support, and/or what capabilities each of the UEs 105A and 105B is not permitted to support, or both. The sidelink positioning capabilities that a UE is permitted to support or not permitted to support may include permission or restrictions on one or more of a sidelink PRS transmission time, sidelink PRS measurement time, sidelink PRS transmission duration, sidelink PRS measurement duration, bandwidth of sidelink PRS that can be transmitted, bandwidth of sidelink PRS that can be measured, RF frequency of sidelink PRS that can be transmitted, RF frequency of sidelink PRS that can be measured, signal coding of sidelink PRS that can be transmitted, signal coding of sidelink PRS that can be measured, periodicity of sidelink PRS transmissions, periodicity of sidelink PRS that is measured, transmission power for sidelink PRS transmission, transmission power for sidelink PRS that is measured, or any combination thereof.

Sidelink positioning capabilities may be fixed and static (e.g. dependent on UE implementation which may never change or may be changed infrequently via a software upgrade to the UE). Sidelink positioning resources may depend on available spectrum for SL PRS (e.g. whether PLMN licensed spectrum, unlicensed spectrum or Intelligent Transportation System (ITS) spectrum for V2X is available and permitted to be used) and/or on pre-existing positioning sessions and/or positioning procedures that a UE may already be supporting or part of. The pre-existing positioning sessions and/or positioning procedures may mean that a UE is not able to transmit and/or measure SL PRS at certain times for a new SL positioning session because at these times the UE needs to be transmitting and/or measuring SL PRS for the pre-existing positioning sessions and/or positioning procedures. Similarly, certain SL PRS characteristics like frequency or coding that are already in use for the pre-existing positioning sessions may not be available to be used for the new SL (or SLPP) positioning session. For example, usage of certain SL PRS characteristics for a new positioning sessions that are already in use for the pre-existing positioning sessions might prevent SL PRS transmissions for the new positioning session or pre-existing positioning sessions from being uniquely identified by UEs involved in the new positioning session or pre-existing positioning sessions which could then cause errors in location measurements and location results. Controlling the usage of SL PRS characteristics for a new positioning session by exchanging sidelink positioning resources that are allowed and/or not allowed may prevent such errors from occurring.

The service requirements that are exchanged at stage 1 may include an indication of at least one of an immediate (e.g. single) location at a current time, a deferred location (e.g. at a later time), a periodic location, a triggered location, a type or types of location result (e.g. relative location, global location, range, direction), a QoS of location results (e.g. location result accuracy, location result response time or latency, location periodicity, location reliability), or some combination of these. The service requirements that are exchanged may define the type(s) of location (e.g., single or periodic), accuracy, latency, periodicity, reliability that each UE requires or expects in the sidelink positioning session.

At stage 2, the UE 105A may send to UE 105B a proposed sidelink positioning signal configuration, e.g., PRS1, PRS2 configuration, e.g., using an SLPP Provide Positioning Signal Configuration message or SLPP Provide Assistance Data message, as discussed above. The PRS1 configuration (in this example) may define SL PRS to be transmitted later by UE 105A, while the PRS2 configuration (in this example) may define SL PRS to be transmitted later by UE 105B, The PRS1 and PRS2 configurations, for example, may be defined and proposed by UE 105A based on the capabilities, resources and service requirements exchanged at stage 1 which may include QoS of UE 105A and 105B. The PRS1 and PRS2 configurations, for example, may be the same as or similar to PRS configurations defined in 3GPP TS 37.355 for LPP except that they may refer to SL PRS transmission on a sidelink communication channel between UEs 105A and 105B. For example, the PRS1 and PRS2 configurations may each include specifications of SL PRS transmission starting time, SL PRS transmission duration, SL PRS bandwidth, SL PRS RF frequency (or frequencies), SL PRS signal coding, SL PRS transmission periodicity, SL PRS transmission power, SL PRS muting and/or SL PRS frequency hopping. Rules and guidelines may be standardized to ensure that the proposed PRS configurations PRS1 and PRS2 are compatible with the capabilities, resources and service requirement of UEs 105A and 105B, which may include QoS of both UEs.

At stage 3, the UE 105B may send a message to the UE 105A to confirm the proposed positioning signal configuration, e.g., the PRS1, PRS2 configurations, e.g., using an SLPP Confirm Positioning Signal Configuration or SLPP Provide Assistance Data Confirm, as discussed above. In some implementations, the UE 105B may instead reject the proposed positioning signal configuration at stage 3 and UE 105A may then propose a different positioning signal configuration until the UE 105A confirms the positioning signal configuration. In some implementations, the UE 105B may send to the UE 105A a modified proposed positioning signal configuration and the UE 105A may confirm the modified positioning signal configuration or may send another modified proposed positioning signal configuration to UE 105B. In some implementations, stage 3 may be omitted when the PRS1, PRS2 configurations sent at stage 2 are acceptable to UE 105B, which may reduce signaling.

At stage 4, the UE 105A transmits SL positioning signals corresponding to the PRS1 configuration and the UE 105B measures these positioning signals (e.g. based on UE 105B already knowing the PRS1 configuration). The UE 105B, for example, may measure one or more of a receive time-transmission time difference (Rx-Tx), a round trip signal propagation time (RTT), a reference signal received power (RSRP), a reference signal received quality (RSRQ), an angle of arrival (AOA), and a time of arrival (TOA) of the PRS1 transmitted by UE 105A.

At stage 5, the UE 105B transmits SL positioning signals corresponding to the PRS2 configuration and the UE 105A measures these positioning signals (e.g. based on UE 105A already knowing the PRS2 configuration). The UE 105A, for example, may measure one or more of an RTT, Rx-Tx, RSRP, RSRQ, AOA, AOD, and TOA of the PRS2 transmitted by UE 105B.

At stage 6, the UE 105A and UE 105B exchange measurements obtained at stage 4 and stage 5. The exchange of measurements, for example, may indicate a revised SL PRS configuration used at stage 4 or stage 5 for transmission of SL PRS if there was any difference to the PRS1 and/or PRS2 configuration (e.g. concerning an exact time or duration of SL PRS transmission) and may further provide the measurements generated at stage 4 or stage 5. As an example, if the SL positioning signals (SL PRS) transmitted by UE 105A at stage 4 corresponding to the PRS1 configuration sent by UE 105A at stage 2 do not exactly match the PRS1 configuration (e.g. because UE 105A slightly delayed the SL PRS transmission because some other UE was transmitting at the transmission time(s) indicated in the PRS1 configuration), then UE 105A may include in the revised SL PRS configuration sent by UE 105A at stage 6, the correct transmission time(s) actually used by UE 105A at stage 4. The UE 105B may then use the correct transmission time(s) for UE 105A received in the revised SL PRS configuration at stage 6 at a later time when calculating any location results (e.g. at stage 7). Exchanging measurements at stage 6 may include both of UE 105A and UE 105B sending their measurements and/or revised SL PRS configurations to the other UE or just one of UE 105A or UE 105B sending its measurements and/or revised SL PRS configuration to the other UE.

At stage 7, the UE 105A and UE 105B may each calculate location results, e.g., range and/or direction between UE 105A and 105B, relative locations, absolute locations, velocities, relative velocities, or any combination thereof, based on the measurements generated at stages 4 and 5 and received (or sent) at stage 6 and/or the revised SL PRS configurations received (or sent) at stage 6. For example, the UEs may determine a range between UE 105A and UE 105B based on Rx-Tx measurements of the PRS signals or based on equivalent TODi and TOAi measurements for the PRSi signals (where i=1 for PRS transmitted by UE 105A in stage 4 and i=2 for PRS transmitted by UE 105B in stage 5, and c represents the speed of transmission of an electromagnetic wave, e.g., speed of light) as:

$$Range = \vert \frac{( {TOA}_{2} - {TOD}_{1} ) + ( {TOA}_{1} - {TOD}_{2} )}{2 c} \vert \qquad Eq . 1$$

The location result(s) determined at stage 7 may then be exchanged, at stage 8. Exchanging location results at stage 8 may include both of UE 105A and UE 105B sending their location results to the other UE or just one of UE 105A or UE 105B sending its location results to the other UE. In the latter case, just the UE which sends its location results to the other UE may calculate its location results at stage 7.

As illustrated in stage 9, stages 4-8 may be repeated as desired by UE 105A and UE 105B. For example, stages 4-8 may be repeated at stage 9 to enable periodic or triggered location results for UE 105A and UE 105B.

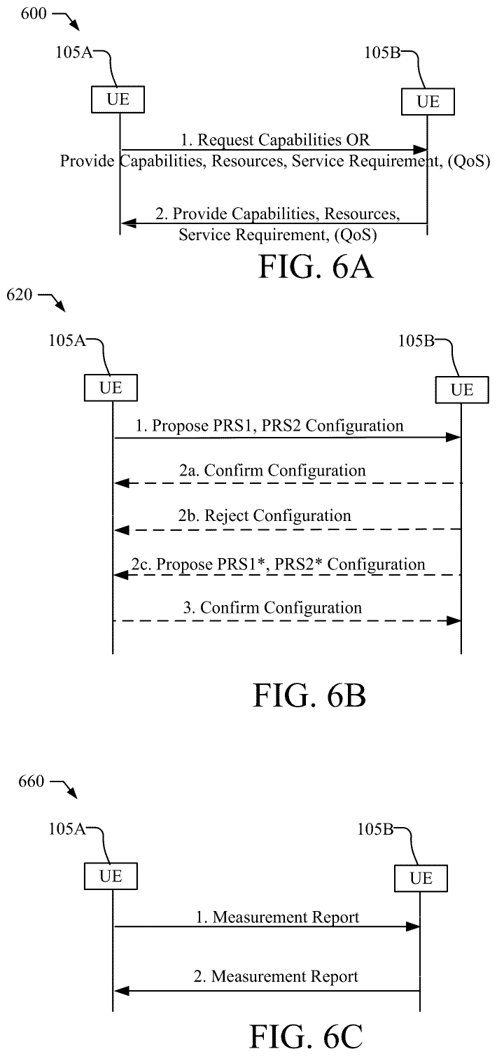

FIG. 6A is a signal flow 600 illustrating the signaling between UE 105A and UE 105B for a sidelink positioning capabilities exchange, including the exchange of capabilities, resources, and service requirements, which may include QoS, which may correspond to stage 1 of FIG. 5. As illustrated in signal flow 600, at stage 1, the UE 105A may send to the UE 105B a (e.g. SLPP) Request Capabilities message, a (e.g. SLPP) Provide Capabilities message or a (e.g. SLPP) Provide Capabilities, Resources, and Service Requirements message, which may include QoS. At stage 2, and in response to the Request Capabilities, the Provide Capabilities or the Provide Capabilities, Resources, and Service Requirements message, the UE 105B may send a (e.g. SLPP) Provide Capabilities message or a (e.g. SLPP) Provide Capabilities, Resources, and Service Requirements message, which may include QoS, to the UE 105A.

FIG. 6B is a signal flow 620 illustrating the signaling between UE 105A and UE 105B for a positioning signal configuration and confirmation exchange and may correspond to stages 2 and 3 of FIG. 5. As illustrated, at stage 1 of signal flow 620, the UE 105A sends to UE 105B a proposed positioning signal configuration, e.g., PRS1, PRS2 configuration, which corresponds to stage 2 of FIG. 5 and may be included in an SLPP Provide Assistance Data message or an SLPP Provide Positioning Signal Configuration message. At stage 2a, the UE 105B may send to UE 105A a confirm configuration message, which corresponds to stage 3 of FIG. 5 and may be an SLPP Confirm Positioning Signal Configuration message or an SLPP Provide Assistance Data Confirm message. Alternatively, at stage 2b, the UE 105B may send to UE 105A a reject configuration message which may be an SLPP Reject Positioning Signal Configuration message or an SLPP Provide Assistance Data Reject message. In response to the reject configuration message from stage 2b, the UE 105A may prepare another positioning signal configuration and stages 1 and 2a or 2b are repeated. In another implementation, at stage 2c, the UE 105B may send to UE 105A a modified positioning signal configuration, e.g., with proposed modified PRS1*, PRS2* configurations, which may be included in an SLPP Provide Assistance Data message or an SLPP Provide Positioning Signal Configuration message. In response to stage 2c, the UE 105A may send a confirm configuration message to UE 105B at stage 3, which may be an SLPP Confirm Positioning Signal Configuration message or an SLPP Provide Assistance Data Confirm message. Alternatively, the UE 105A may further modify the positioning signal configuration by repeating stages 1 and 2a or 2b.

FIG. 6C is a signal flow 660 illustrating the signaling between UE 105A and UE 105B for a measurement exchange, and may correspond to stage 6 of FIG. 5. As illustrated in signal flow 660, at stage 1, the UE 105A may send to the UE 105B a measurement report, which may include information related to the PRS transmitted by the UE 105A at stage 4 of FIG. 5, such as an exact time or times of transmission, etc. and may further include measurements generated by the UE 105A of the PRS transmitted by the UE 105B at stage 5 of FIG. 5. The measurement report for stage 1 may be an SLPP Provide Location Information message.

Similarly, at stage 2, the UE 105B may send to the UE 105A a measurement report, which may include information related to the PRS transmitted by the UE 105B at stage 5 of FIG. 5, such as an exact time or times of transmission, etc. and may further include measurements generated by the UE 105B of the PRS transmitted by the UE 105A at stage 4 of FIG. 5. The measurement report for stage 2 may be an SLPP Provide Location Information message.

Thus, as discussed for stage 1 of FIG. 5, as well as discussed for stage 1 shown in FIG. 6A, a sidelink positioning message sent by the UE 105A may include sidelink positioning capabilities and sidelink positioning resources of the UE 105A. The sidelink positioning message may further include the sidelink positioning Service Requirement of the UE 105A as discussed for stage 1 of FIG. 5 and FIG. 6A.

Moreover, the UE 105A may receive a second sidelink positioning message from the UE 105B. For example, as discussed for stage 1 of FIG. 5, as well as discussed for stage 2 shown in FIG. 6A, the second sidelink positioning message received from UE 105B may include the sidelink positioning capabilities and sidelink positioning resources of UE 105B. The second sidelink positioning message received from UE 105B may further include the sidelink positioning Service Requirement of UE 105B as discussed for stage 1 of FIG. 5 and stage 2 of FIG. 6A.

As illustrated for stages 2-8 of FIG. 5, the UE 105A may exchange additional sidelink positioning messages with UE 105B, which may be based on the sidelink positioning capabilities and the sidelink positioning resources of UE 105B. Each of the additional sidelink positioning messages may be further based on the sidelink positioning Service Requirement of the UE 105B. For example, as discussed for stages 2-8 of FIG. 5, as well as discussed in signal flows 620 and 660 of FIGS. 6B and 6C, the additional sidelink positioning messages exchanged with UE 105B may include proposed positioning signal configurations, confirmation (or rejection or modification) of the proposed positioning signal configurations, requests for measurements and/or measurements of sidelink positioning PRS and location results determined from the measurements of sidelink positioning PRS.

As illustrated by stage 7 of FIG. 5, the UE 105A may determine the location of the UE 105B based on the additional sidelink positioning messages.

The pairwise sidelink positioning illustrated in FIGS. 5, 6A, 6B, and 6C may be expanded and extended for group operation, e.g., with a group of UEs, e.g., as illustrated by the UE group 210 in FIG. 2. The group of UEs, for example, may be sufficiently small that direct discovery and direct sidelink signaling are possible between UEs in the group of UEs. Various sidelink positioning messages sent by the UEs in the group may be transmitted using groupcast or multicast so that each sidelink positioning message is broadcast once using sidelink signaling to all recipient UEs.

FIG. 7 by way of example, shows a signal flow 700 illustrating the signaling for group operation of sidelink positioning for a plurality of UEs, illustrated as UE 105A, 105B, 105C, . . . 105Z, sometimes collectively referred to as UEs 105. The group of UEs 105 may comprise a small number of UEs (e.g., up to 20) for which direct discovery and direct SL signaling are possible. The UEs 105, for example, may be, e.g., the UEs illustrated in FIG. 1 or any of the UEs illustrated in group 210 shown in FIG. 2. The sidelink positioning illustrated in FIG. 7 is independent of a network and thus, the UEs shown in FIG. 7 may be the out of coverage UEs in subgroup 216 in FIG. 2. The signaling performed in signal flow 700 may be similar to or the same as the SLPP signaling discussed above in reference to FIG. 2 and as illustrated in signal flow 500 in FIG. 5, except that the SLPP signaling can involve a larger number of UEs. If desired, the signaling may be performed directly, as illustrated or via relays and/or via a network. It is noted that the number of UEs in signal flow 700 is typically more than two though in a limiting case might be two (in which case two of the UEs shown in FIG. 7 are not present).

The signal flow 700 illustrates a simple type of SLPP session between the UEs 105 in which there may or may not be explicit session establishment and session termination. When the signal flow 700 is performed with explicit session establishment and session termination, stages 1-11 of FIG. 7 could be performed as part of signal flow 1100 described later for FIG. 11 where stages 1-11 of FIG. 7 replace stages 9-13 in FIG. 11.

At stage 0 of FIG. 7, discovery of UEs 105, formation of the group, and establishment of a multicast sidelink communication session is performed. The discovery process may be request-response or announcement based. The discovery phase, for example, may be implemented by one or more UEs 105 to detect other UEs 105 that are available for sidelink positioning and are suitable for joining the group. For example, discovery messages may be exchanged between the UEs 105 to determine nearby UEs 105 that are available to participate in sidelink positioning. For example, UE 105A may broadcast a discovery based message using sidelink signaling which UEs 105B, 105C and 105Z may each receive and respond to by each transmitting a similar discovery based response message back to UE 105A using sidelink signaling. The UEs 105 may also exchange (or may be pre-configured with) one or more group criteria parameters for group formation, such as an approximate maximum distance between pairs of UEs (to help ensure UEs 105 can communicate directly with one another), a minimum period of time that any UE 105 is likely to be in communication with other UEs 105 (to help ensure that UEs 105 can communicate directly with one another for some minimum time period), and/or a common direction and/or common range of speed of the UEs 105 (to help ensure that UEs 105 will remain nearby to one another). Based on the group criteria parameters, the UEs 105 may determine whether to form a group, which UEs 105 should or should not belong to the group or whether and when to add additional UEs 105 later to the group and/or to remove an existing UEs 105 from the group. For example, the UEs 105 may determine a group status indication for each UE 105 indicating inclusion in the group or exclusion from the group. In FIG. 7, for example, it is assumed that all UEs 105A, 105B, 105C, . . . 105Z meet the one or more group criteria and are included in the group. Additional messages may be exchanged between the UEs 105 to explicitly establish a sidelink communication or positioning session between the UEs 105. For example, UE 105A may multicast a single request (e.g. an SLPP request) to UEs 105B, 105C and 105Z to start an SLPP positioning session and UEs 105B, 105C and 105Z may each return a response (e.g. an SLPP response) to UE 105A agreeing to start the SLPP positioning session.

At stage 1, the UEs 105 may exchange SLPP capabilities, resources, and service requirements, which may include QoS, for example, using SLPP Request Capabilities and Resources and SLPP Provide Capabilities and Resources messages as discussed above. The exchange of capabilities, resources, and service requirements, which may include QoS, may be similar to the signal flow 600 illustrated in FIG. 6A, but with additional UEs. For example, the UEs 105 may initially exchange capabilities by each sending a single groupcast SLPP message from each UE 105 to all the other UEs 105. The capabilities that are exchanged may define what each of the UEs 105 is implemented to support. The resources that are exchanged may define what capabilities each of the UEs 105 is permitted to support and/or is not permitted to support. The sidelink positioning capabilities that a UE 105 is permitted to support or not permitted to support may include permission or restrictions on one or more of a sidelink PRS transmission time, sidelink PRS measurement time, sidelink PRS transmission duration, sidelink PRS measurement duration, bandwidth of sidelink PRS that can be transmitted, bandwidth of sidelink PRS that can be measured, RF frequency of sidelink PRS that can be transmitted, RF frequency of sidelink PRS that can be measured, signal coding of sidelink PRS that can be transmitted, signal coding of sidelink PRS that can be measured, periodicity of sidelink PRS transmissions, periodicity of sidelink PRS that is measured, transmission power for sidelink PRS transmission, transmission power for sidelink PRS that is measured, or any combination thereof. Sidelink positioning capabilities may be fixed and static as discussed for stage 1 of FIG. 5. Sidelink positioning resources may depend on available spectrum for SL PRS and/or on pre-existing positioning sessions and/or positioning procedures that a UE 105 may already be supporting or part of as discussed for stage 1 of FIG. 5. The service requirements of each of the UEs 105 may be as described for stage 1 of FIG. 5.

At stage 2, the UE 105A may send to the other UEs 105 a proposed positioning signal configuration, e.g., PRS1, PRS2, PRS3, . . . PRSn configuration, e.g., using an SLPP Provide Positioning Signal Configuration message or SLPP Provide Assistance Data message, as discussed above. The PRS1 configuration (in this example) may define SL PRS to be transmitted later by UE 105A, the PRS2 configuration (in this example) may define SL PRS to be transmitted later by UE 105B, the PRS3 configuration (in this example) may define SL PRS to be transmitted later by UE 105C, and the PRSn configuration (in this example) may define SL PRS to be transmitted later by UE 105Z, The PRS1, PRS2, PRS3 and PRSn configurations, for example, may be defined and proposed by UE 105A based on the capabilities, resources and service requirements exchanged at stage 1 which may include QoS of each of the UEs 105. The PRS1, PRS2, PRS3 and PRSn configurations, for example, may each be as described for PRS1 and PRS2 for stage 2 of FIG. 5.

At stage 3, each of the UEs 105B, 105C, . . . 105Z may send a message to the UE 105A to confirm the proposed positioning signal configuration, e.g., the PRS1, PRS2, PRS3, . . . PRSn configurations, e.g., using an SLPP Confirm Positioning Signal Configuration or SLPP Provide Assistance Data Confirm, as discussed above. In some implementations, a UE 105 (e.g. UE 105B) may instead reject the proposed positioning signal configuration at stage 3 and may further indicate which PRS configuration(s) are being rejected. and UE 105A may then propose a different positioning signal configuration (or just different PRS configurations for the PRS configuration(s) which are being rejected) until each of the other UEs 105 confirms the positioning signal configuration. In some implementations, a UE 105 (e.g. UE 105B) may send to the UE 105A and to other UEs 105 in the group a modified proposed positioning signal configuration and the UE 105A and the other UEs 105 may confirm the modified positioning signal configuration or may send another modified proposed positioning signal configuration to other UEs 105. In some implementations, stage 3 may be omitted when the PRS1, PRS2. PRS3, . . . PRSn configurations sent at stage 2 are acceptable to each of the UEs 105B, 105C, . . . 105Z which may reduce signaling.

At stage 4, the UE 105A transmits SL positioning signals corresponding to the PRS1 configuration and UEs 105B, 105C, . . . 105Z each measure these positioning signals (e.g. based on UE 105B, UE 105C, . . . UE 105Z already each knowing the PRS1 configuration). The UEs 105B, 105C, . . 105Z, for example, may each measure one or more of a reference signal time difference (RSTD), RTT, Rx-Tx, RSRP, RSRQ, AOA, AOD, TOA of the PRS1 transmitted by UE 105A.

At stage 5, the UE 105B transmits positioning signals PRS2 and the remaining UEs 105 each measure the positioning signals PRS2, similar to PRS1 measurement at stage 4.

At stage 6, the UE 105C transmits positioning signals PRS3 and the remaining UEs 105 measure the positioning signals PRS3, similar to PRS1 measurement at stage 4.

At stage 7, the UE 105Z transmits positioning signals PRSn and the remaining UEs 105 measure the positioning signals PRSn. similar to PRS1 measurement at stage 4.

At stage 8, the UEs 105 exchange measurements. The exchange of measurements may be similar to the signal flow 660 illustrated in FIG. 6C, but with additional UEs, and with the measurements, for example, exchanged via a single groupcast SLPP message sent by each UE 105 to all the other UEs 105 in the group. The exchange of measurements, for example, may indicate a revised SL PRS configuration used by a UE 105 for transmission of SL PRS (e.g. as discussed for stage 6 of FIG. 5), and may further provide the measurements obtained by the UE 105—e.g. at one of stages 4, 5, 6 or 7.

At stage 9, each UE 105 may determine location results, e.g., range and/or direction between the UE 105 and each of one or more other UEs 105 in the group, relative locations of one or more of the UEs 105, absolute locations, velocities, relative velocities, or any combination thereof, based on the measurements generated at stages 4-7 and received (or sent) at stage 8 and/or the revised SL PRS configurations received (or sent) at stage 8. In some embodiments, only one UE 105 (e.g. UE 105A) or a subset of the UEs 105 may determine location results.

The location result(s) determined at stage 9 may then be exchanged, at stage 10. Exchanging location results at stage 10 may include each of UEs 105A, 105B, 105C . . . 195Z sending its location results to all the other UEs 105 in the group, or just one UE 105 (e.g. UE 105A) or a subset of the UEs 105 sending location results to the other UEs 105. In the latter case, just the UE 105 (or the subset of UEs 105) which sends its location results to the other UEs 105 may calculate location results at stage 9.

As illustrated at stage 11, stages 4-10 may be repeated as desired by the UEs 105. For example, stages 4-10 may be repeated at stage 11 to enable periodic or triggered location results for the UEs 105 to be obtained.

Thus, as shown in FIG. 7 when a UE 105, such as UE 105A, belongs to a group of UEs that contains two or more UEs, the UE 105A may send a sidelink positioning message to all other UEs in the group of UEs, e.g., UEs 105B, 105C, . . . 105Z, e.g., based on sidelink multicasting, so that the sidelink positioning message is broadcast or multicast once using SL signaling to all recipients UEs. For example, as discussed in stage 1 of FIG. 7, as well as discussed in stage 1 shown in FIG. 6A, the sidelink positioning message sent by the UE 105A may include sidelink positioning capabilities and sidelink positioning resources of the UE 105A. The sidelink positioning message may further include the sidelink positioning Service Requirement of the UE 105A as discussed in stage 1 of FIG. 7 and FIG. 6A.

Moreover, as further discussed in stage 1 of FIG. 7, the UE 105A may receive a second sidelink positioning message from each of the other UEs in the group of UEs, e.g., UEs 105B, 105C, . . . 105Z, e.g., based on sidelink multicasting. For example, as discussed in stage 1 of FIG. 7, as well as discussed in stage 2 shown in FIG. 6A, the second sidelink positioning message received from each of the other UEs may include sidelink positioning capabilities and sidelink positioning resources of the each UE. The second sidelink positioning message received from each UE may further include the sidelink positioning Service Requirement of the each UE as discussed in stage 1 of FIG. 7 and FIG. 6A.

As illustrated by stages 2-8 of stage 7, the UE 105A may exchange additional sidelink positioning messages with at least some UEs in the group of UEs, e.g., UEs 105B, 105C, . . . 105Z, e.g., based on sidelink multicasting. The additional sidelink positioning messages, for example, may be based on the sidelink positioning capabilities and the sidelink positioning resources of each of the at least some UEs. Each of the additional sidelink positioning messages may be further based on the sidelink positioning Service Requirements of each UE 105. For example, as discussed in stages 2-8 of FIG. 7, as well as discussed in signal flows 620 and 660 of FIGS. 6B and 6C, the additional sidelink positioning messages exchanged with at least some UEs may include proposed positioning signal configurations, may confirm (or reject or modify) the proposed positioning signal configurations, and/or may request measurements or provide measurements of SL PRS.

As illustrated by stage 9, the UE 105A may determine location results regarding the at least some of the UEs based on the additional sidelink positioning messages.

For group operation of sidelink positioning, such as illustrated in FIG. 7, the group of UEs should be initially determined and optionally formed, e.g., based on one or more criteria. Moreover, modification of the group of UEs may be necessary as UEs leave or enter the group area.

Group determination and formation for sidelink positioning may use Proximity-based Services (ProSe) or V2X services, e.g., for discovery and establishment of the group as illustrated in stage 0 of FIGS. 5 and 7. Various criteria may be used for including UEs in the same group. For example, for inclusion within a group, one criteria may be the ability for discovery via ProSe or V2X and the ability to communicate directly (via sidelink signaling) with other UEs in the group. Other criteria may include a maximum distance restriction, e.g., exclude from the group any UEs that are generally more distant from other UEs in the group than a maximum distance threshold; a time restriction, e.g., exclude from the group any UEs that are (or are likely to be) in communication with other UEs in the group for less than a minimum time duration threshold; and a direction or speed restriction, e.g., exclude from the group any UEs that are moving in a different direction than other UEs in the group or are moving at a speed that differs from the speeds of other UEs in the group by more than a maximum speed difference threshold. The criteria, e.g., thresholds to determine whether a UE meets various requirements to join the group, may be dependent on an environment and application. By way of example, the distance, time, and direction or speed criteria used in group formation for V2X highway, V2X local road, or V2X carpark applications may differ. Once a group is established, periodic ProSe or periodic V2X signaling may be used to determine when a UE should leave the group and when new UEs should join the group, e.g., based on whether the group criteria are met. Within a group, the UEs may be assigned member IDs (e.g., 1, 2, 3 etc.) for identification within the group and in SLPP messages. The group member IDs, for example, may be used to determine which UE will lead, coordinate and/or initiate an SLPP positioning session, a position method or a position method type, e.g. which UE will propose PRS configurations to other UEs, such as illustrated at stage 2 of FIGS. 5 and 7. A group may be restricted to one position method type only (e.g., SL NR PRS), while other position method types (e.g., SL LTE PRS or RTK) may be used by a different group. Restricting a group to one position method type may avoid scenarios where not all UEs in a group support the same position method types and may simplify procedures and messaging. Alternatively, to maximize signaling efficiency, the same group of UEs may employ multiple position method types and/or multiple position methods, where not all UEs in the group necessarily support exactly the same position method types or exactly the same position methods.

As noted, embodiments can provide for the efficient allocation of SL resources by an entity coordinating SL positioning (e.g., a coordinating UE or LMF) through the use of resource usage maps and resource capability maps, which can be provided to the coordinating entity by each UE participating in the SL positioning.

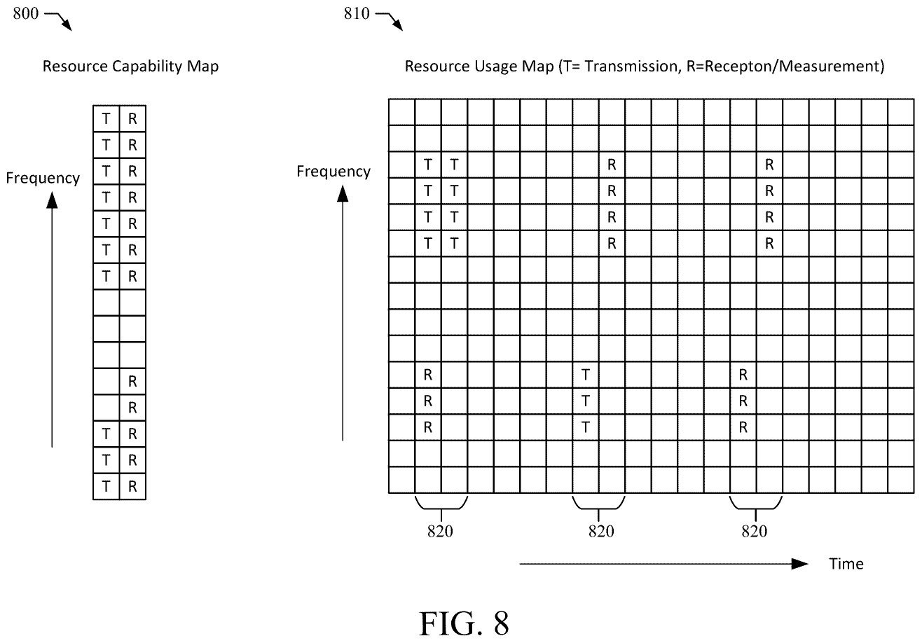

FIG. 8 is an illustration of an example resource capability map 800 and an example resource usage map 810, according to an embodiment. As with other figures herein, FIG. 8 is provided as a non-limiting example. Different embodiments may have additional and/or alternative features and may be organized and a different manner. Further, it will be understood that the resource capability map 800 and/or resource usage map 810 may be encoded in any of a variety of ways (e.g., where the map may be represented by a bit stream, octet stream, etc., in which rows and/or columns in the map may be represented by a predetermined number of bits, or the like) and the illustrations in FIG. 8 are visual representations of what is encoded and transmitted by UEs.

As illustrated, resource capability map 800 is divided into frequency resources, and resource usage map 810 is divided into frequency and time resources, where each resource is represented by a square in the grid of the map. The resource capability map 800 of a given UE represents the capabilities of the UE for performing SL positioning. In particular, a “T” in a given frequency resource indicates that the UE is capable of transmitting an SL positioning signal (e.g., SL PRS) using that frequency resource. Similarly, an “R” in a given frequency resource indicates that the UE is capable of receiving/measuring an SL positioning signal using that frequency resource. The resource usage map 810 of a UE shows times and frequencies at which the UE is currently scheduled to transmit (T) and receive/measure (R) SL PRS. Depending on how resources are quantized, embodiments may allow for resources to be identified as T/R (not shown), indicating that the UE is (or is capable of, in the case of a resource capability map) both transmitting/receiving at a given resource.

The fundamental quantities in the resource capability map 800 and resource usage map 810 are frequency and time. With respect to frequency, these maps 800, 810 may span across one or more frequency bands used for SL positioning (e.g., cellular, Intelligent Transport Systems (ITS), unlicensed spectrum). Different frequency bands may be represented on a single map or multiple maps. Frequency and time may be quantized to sufficiently represent used and unused SL positioning resources. According in some embodiments, time may be quantized into subframe-based time units and frequency may likewise be quantized into suitable units of frequency range, where these units may be selected to represent SL resources. For example, a frequency range or frequency resource may correspond to a small range of frequencies such as an OFDM subcarrier, or set of contiguous subcarriers, for 4G LTE or 5G NR. A particular frequency range or frequency resource may be indicated by one or more frequencies (e.g. a minimum, maximum and/or center frequency), a frequency difference (e.g. difference between a minimum and maximum frequency), a bandwidth and/or some other (e.g. standardized) designation.

In some embodiments, elements (shown as squares in FIG. 8) of resource usage map 810 may each comprise one or more resource blocks or one or more resource elements (which can each have both frequency and time dimensions) and which may be as defined by 3GPP for 4G LTE or 5G NR. In embodiments in which ITS and/or unlicensed spectrum are used, a suitable equivalent for resource blocks and resource elements may be used. Depending on how time and frequency resources are quantized, each time and frequency resource in resource usage map 810 (as shown by each square in FIG. 8) may represent a combination of smaller time and frequency resources. A convention may then be used in which, if a UE is transmitting during any of the smaller time and frequency resources (or for at least a threshold number of the smaller time and frequency resources), the UE will indicate a transmission (T) for the time and frequency resource representing the combination of the smaller time and frequency resources. Additionally or alternatively, a similar convention may be used for reception/measurement (R). According to some embodiments, transmission (T) and reception/measurement (R) by a UE may be based on established definitions for SL positioning. Such definitions may be found in applicable 3GPP technical specifications such as 3GPP TS 38.211 and TS 38.214.

In order to support other signaling by UEs for both SL (PC5) and UL/DL (Uu)—e.g. that may be occurring and may even be unavoidable in the case of UEs in coverage (and connected state), SL PRS transmission (T) and reception (R) may be constrained to occur (in a time dimension) only during preconfigured SL PRS occasions, e.g. such as SL PRS occasions 820 shown for resource usage map 810. SL PRS occasions may comprise periodic time periods each of equal length during which UEs only transmit or receive and measure SL PRS and do not engage in other signaling activity using the same frequency range(s). Different types of frequency range (e.g. ITS, unlicensed, licensed) can have separate (though not necessarily independent) SL PRS occasions. There might also be separate SL PRS occasions for different services for which SL positioning is used, e.g. V2X, public safety (PS), commercial. PLMNs can advertise or at least control the assignment of SL PRS occasions for their own licensed spectrum. A government department like the US Department of Transportation (DOT) might do the same for V2X related SL PRS occasions in ITS and unlicensed spectrum. For example, for V2X, RSUs and possibly a government owned PLMN could indicate the SL PRS occasion assignments for V2X to all UEs to ensure that separate groups of UEs all adhere to the same SL PRS occasion assignments. The configured SL PRS occasions can also be dynamically expanded or reduced depending on overall UE demand.

According to some embodiments, a resource usage map 810 may reflect and include only resources applicable to SL positioning (SL PRS) occasions, and may exclude resources that are not used for SL positioning. That is, embodiments may utilize modified resource usage maps that include information only for SL positioning resources, including transmission and reception/measurement used for existing SL positioning. In such embodiments, maps may include information limited to positioning occasions for SL positioning in the time domain, which, as previously noted, may be pre-designated and/or occur at fixed time intervals. With respect to resource usage map 810, for example, if SL positioning occasions occur only during time intervals shown as pairs of columns 820, a UE may provide a modified version of resource usage map 810 in which only columns 820 are included.

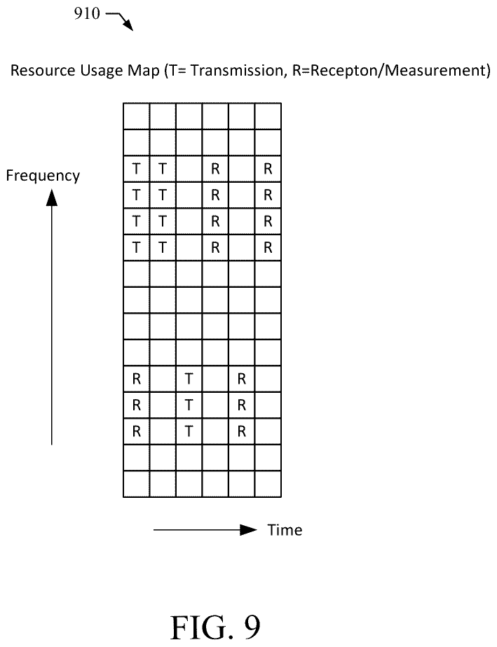

The resource usage map 910 in FIG. 9 illustrates what the resulting modified map would include. Because the timing of SL positioning occasions may be different in cellular, ITS, and unlicensed frequency bands, different maps may be provided for these different frequency bands, as noted above. Ultimately, modifying resource usage maps to include only resources for SL positioning occasions would not fundamentally change the use of resource usage maps as described above (e.g., with respect to FIG. 8). However, as shown in FIG. 9, such a modified map usage would have reduced size/overhead, which could be advantageous in various circumstances. It can be further noted that a type of encoding for the transmission of resource capability and/or resource usage maps (e.g., maps 800, 810, 910) may be selected to efficiently represent map information (e.g., repeated map information such as the same resource usage between frequencies, multiple resources having a similar designation (T, R, or blank) that are adjacent in time and/or frequency, etc.) to help reduce overhead related to encoding these maps.

According to some embodiments, one or more additional parameters may be included with maps 800, 810, and 910. These additional parameters may include, for example, other configuration parameters of SL PRS such as bandwidth, duration, coding, periodicity (e.g., of SL PRS transmissions, receptions/measurements, etc.), and UE capability to perform simultaneous measurements of multiple SL PRS transmissions, etc. The resource usage map 810 shows when (time) and where (frequency) the UE is currently transmitting (T) and receiving/measuring (R) SL PRS for other SLPP sessions for the UE. Depending on the type of additional parameter, each additional parameter may apply to a single time and frequency resource (e.g., a single square in resource usage map 810) or to multiple time and frequency resources for the entire map. Thus, embodiments may allow for resource usage map 810 to be encoded such as to indicate time and frequency resource(s) to which additional parameters apply (e.g., on a per-time and frequency resource basis, or applicable to all or a subset of time and frequency resources of the usage map 810).

According to some embodiments, one or more UEs participating in SL positioning may each provide a further resource map that indicates an average level of background RF activity (e.g. SL PRS transmission activity and other transmission activity) produced by other UEs and/or other entities (e.g. gNBs) at each frequency (e.g. an interference indication, which may be measured by the UE). In some embodiments, a time element also may be indicated (e.g., a periodicity/timing of interference, if detected). A coordinating entity receiving this information then may be able to identify frequencies in which less resource assignment may be desirable (e.g., frequencies having a relatively large amount of background RF) and where more resource assignment may be possible (e.g., frequencies having a relatively small amount of background RF).

As noted, an entity (e.g., a coordinating UE or LMF) that coordinates an SL positioning session (e.g., SLPP session) can receive resource capability and resource usage maps from some or all UEs in a group of UEs participating in the SL positioning session. With these maps, the coordinating entity can determine when (time) and where (frequency) the UEs can transmit and receive/measure SL PRS without disturbing current T/R activity of the UEs. Additionally, currently-scheduled UE transmission (T) activity could be re-used to avoid new SL PRS transmission by having UEs in a new session measure the current SL PRS transmission of other UEs. As an example, a coordinating entity can (logically at least) overlay all of the resource usage maps on top of one another (e.g., where 2D maps in FIG. 8 are overlaid on each other to form a 3D map representing the entire group of UEs). The various frequency and time resources (squares in the maps of FIGS. 8 and 9) where there is no T or R activity for any UE would then be candidates for new SL PRS transmission by individual UEs and measurement by other UEs. In addition, where existing SL PRS transmission by a UE (T squares) do not coincide with SL PRS transmission (T squares) from other UEs, the existing SL PRS transmission might be reused by having the other UEs measure this.

This can enable an entity (e.g., a UE or LMF), that coordinates an SL positioning session (e.g., an SLPP session) for a group of UEs, to determine an SL positioning configuration for each UE of the group of UEs, based at least in part on a resource capability map and/or resource usage map obtained by the entity for each UE of the group of UEs. The SL positioning configuration determined for each UE may comprise an SL PRS configuration to be transmitted by the UE, one or more SL PRS configurations to be measured by the UE (e.g. where each SL PRS configuration to be measured is transmitted by some other UE in the group of UEs), or both of these. The entity may send the SL PRS configuration determined for each UE to that UE in an SLPP message (e.g. an SLPP Provide Assistance Data message), for example as at stage 2 in FIG. 5 or stage 2 in FIG. 7.

According to some embodiments, time synchronization requirements across UEs participating in SL positioning may require relatively low accuracy. That is, although embodiments described herein assume time synchronization (common time) among all UEs, the accuracy and precision of this synchronization may be relatively low. For example, synchronization within 1 millisecond (ms) may be enough, in some embodiments. (Other embodiments may allow for even lower precision.) Further, according to some embodiments, GNSS may be used to get the common timing. Additionally or alternatively, other timing sources such as trusted UEs (e.g., roadside units (RSUs)), gNBs, and/or other devices may be used as timing references.

It can be noted that the transmittal (i.e. sending) of resource capability and/or resource usage maps to a coordinating entity by participating UEs can be incorporated into processes for coordinating and performing SL positioning. For example, with respect to the pairwise sidelink positioning signal flow 500 in FIG. 5, UE 105B may provide resource capability and/or resource usage maps to UE 105A (the coordinating UE) at stage 1, in which capabilities, resources, and service requirements are exchanged. Similarly, with respect to the group sidelink positioning signal flow 700 in FIG. 7, UEs 105B, 105C and 105Z may provide resource capability and/or resource usage maps to coordinating UE 105A at stage 1, in which capabilities, resources, and service requirements are exchanged. For embodiments in which SL positioning is network coordinated, the transmittal of resource capability and/or resource usage maps by UEs to an LMF or other coordinating entity in the network similarly may be incorporated into existing operations in network-coordinated SL positioning in which capabilities and resources are exchanged. It can be further noted that the above-described map indicating background RF activity may be sent by a UE in the same operation in which resource capability and/or resource usage maps are sent.

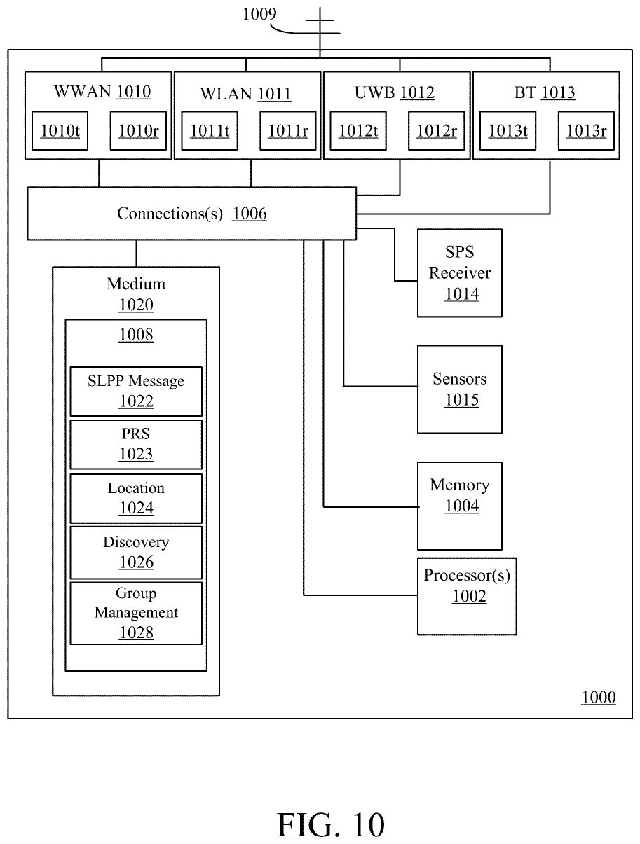

FIG. 10 shows a schematic block diagram illustrating certain exemplary features of a UE 1000, e.g., which may be a UE 105 shown in FIGS. 1, 3, 5, 6A, 6B, 6C, and 7, and any of the UEs illustrated in FIG. 2 and supports sidelink positioning of the UE 1000, including group management, resource usage maps and resource capability maps as described herein. In some instances, the UE 1000 may comprise a coordinating entity that may receive resource capability maps and/or resource usage maps from UEs participating in SL positioning, as described herein. In some instances, the UE 1000 may comprise a UE participating in SL positioning that may determine and transmit resource capability maps and/or resource usage maps to a coordinating entity (e.g., coordinating UE or LMF), as described herein. The UE 1000, for example, may perform the signal flows 300, 500, 600, 620, 660, and 700 shown in respective FIGS. 3, 5, 6A, 6B, 6C, and 7, and accompanying techniques as discussed herein. The UE 1000 may include, for example, one or more processors 1002, memory 1004, an external interface such as at least one wireless transceivers (e.g., wireless network interface) illustrated as Wireless Wide Area Network (WWAN) transceiver 1010, Wireless Local Area Network (WLAN) transceiver 1011, an Ultra-Wideband (UWB) transceiver 1012 and a Bluetooth (BT) transceiver 1013, SPS receiver 1014, and one or more sensors 1015, which may be operatively coupled with one or more connections 1006 (e.g., buses, lines, fibers, links, etc.) to non-transitory computer readable medium 1020 and memory 1004. The SPS receiver 1014, for example, may receive and process SPS signals from satellite vehicles 190 shown in FIG. 1. The one or more sensors 1015, for example, may include an inertial measurement unit (IMU) that may include one or more accelerometers, one or more gyroscopes, a magnetometer, etc. The UE 1000 may further include additional items, which are not shown, such as a user interface that may include e.g., a display, a keypad or other input device, such as virtual keypad on the display, through which a user may interface with the UE 1000. In certain example implementations, all or part of UE 1000 may take the form of a chipset, and/or the like.

The UE 1000 may include at least one wireless transceiver, such as wireless transceiver 1010 for a WWAN communication system and wireless transceiver 1011 for a WLAN communication system, UWB transceiver 1012 for a UWB communication system, BT transceiver 1013 for a Bluetooth communication system, or a combined transceiver for any of WWAN, WLAN, UWB, and BT. The WWAN transceiver 1010 may include a transmitter 1010t and receiver 1010r coupled to one or more antennas 1009 for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The WLAN transceiver 1011 may include a transmitter 1011t and receiver 1011r coupled to one or more antennas 1009 or to separate antennas, for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The UWB transceiver 1012 may include a transmitter 1012t and receiver 1012r coupled to one or more antennas 1009 or to separate antennas, for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The BT transceiver 1013 may include a transmitter 1013t and receiver 1013r coupled to one or more antennas 1009 or to separate antennas, for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The transmitters 1010t, 1011t, 1012t, and 1013t may include multiple transmitters that may be discrete components or combined/integrated components, and/or the receivers 1010r, 1011r, 1012r, and 1013r may include multiple receivers that may be discrete components or combined/integrated components. The WWAN transceiver 1010 may be configured to communicate signals (e.g., with base stations and/or one or more other UEs or other devices) according to a variety of radio access technologies (RATs) such as New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), etc. New Radio may use mm-wave frequencies and/or sub-6 GHz frequencies. The WLAN transceiver 1011 may be configured to communicate signals (e.g., with access points and/or one or more other devices) according to a variety of radio access technologies (RATs) such as 3GPP LTE-V2X (PC5), IEEE 1002.11 (including IEEE 1002.11p), Wi-Fi, Wi-Fi Direct (Wi-Fi D), Zigbee etc. The UWB transceiver 1012 may be configured to communicate signals (e.g., with access points and/or one or more other devices) according to a variety of radio access technologies (RATs) such as personal area network (PAN) including IEEE 802.15.3, IEEE 802.15.4, etc. The BT transceiver 1013 may be configured to communicate signals (e.g., with access points and/or one or more other devices) according to a variety of radio access technologies (RATs) such as a Bluetooth network. The transceivers 1010 1011, 1012, and 1013 may be communicatively coupled to a transceiver interface, e.g., by optical and/or electrical connection, which may be at least partially integrated with the transceivers 1010, 1011, 1012, 1013.

In some embodiments, UE 1000 may include antenna 1009, which may be internal or external. UE antenna 1009 may be used to transmit and/or receive signals processed by wireless transceivers 1010, 1011, 1012, 1013. In some embodiments, UE antenna 1009 may be coupled to wireless transceivers 1010, 1011, 1012, 1013. In some embodiments, measurements of signals received (transmitted) by UE 1000 may be performed at the point of connection of the UE antenna 1009 and wireless transceivers 1010, 1011, 1012, 1013. For example, the measurement point of reference for received (transmitted) RF signal measurements may be an input (output) UE of the receiver 1010r (transmitter 1010t) and an output (input) UE of the UE antenna 1009. In a UE 1000 with multiple UE antennas 1009 or antenna arrays, the antenna connector may be viewed as a virtual point representing the aggregate output (input) of multiple UE antennas.

The one or more processors 1002 may be implemented using a combination of hardware, firmware, and software. For example, the one or more processors 1002 may be configured to perform the functions discussed herein by implementing one or more instructions or program code 1008 on a non-transitory computer readable medium, such as medium 1020 and/or memory 1004. In some embodiments, the one or more processors 1002 may represent one or more circuits configurable to perform at least a portion of a data signal computing procedure or process related to the operation of UE 1000.

The medium 1020 and/or memory 1004 may store instructions or program code 1008 that contain executable code or software instructions that when executed by the one or more processors 1002 cause the one or more processors 1002 to operate as a special purpose computer programmed to perform the techniques disclosed herein. As illustrated in UE 1000, the medium 1020 and/or memory 1004 may include one or more components or modules that may be implemented by the one or more processors 1002 to perform the methodologies described herein. While the components or modules are illustrated as software in medium 1020 that is executable by the one or more processors 1002, it should be understood that the components or modules may be stored in memory 1004 or may be dedicated hardware either in the one or more processors 1002 or off the processors.

A number of software modules and data tables may reside in the medium 1020 and/or memory 1004 and be utilized by the one or more processors 1002 in order to manage both communications and the functionality described herein. It should be appreciated that the organization of the contents of the medium 1020 and/or memory 1004 as shown in UE 1000 is merely exemplary, and as such the functionality of the modules and/or data structures may be combined, separated, and/or be structured in different ways depending upon the implementation of the UE 1000.

The medium 1020 and/or memory 1004 may include an SLPP message module 1022 that when implemented by the one or more processors 1002 configures the one or more processors 1002 to transmit and receive sidelink positioning (e.g., SLPP) messages, via the external interface including one or more of wireless transceivers 1010, 1011, 1012, and 1013. The sidelink positioning messages may use SLPP as discussed herein. The one or more processors 1002 may be configured to transmit SLPP messages, via the external interface, directly to one or more other UEs or to broadcast the SLPP messages using groupcast or multicast to a plurality of other UEs. The one or more processors 1002 may be configured to transmit and receive SLPP messages, via the external interface, with a location server (e.g. an LMF) in a PLMN with the SLPP message(s) embedded in an LPP message, embedded in both an LPP and SUPL message (e.g. which may include a SUPL POS message), embedded in just a SUPL message (e.g. which may include a SUPL POS message), or not embedded in an LPP or SUPL message. The one or more processors 1002 may be configured, for example, to transmit and receive, via the external interface, SLPP messages that include an SLPP capabilities request or SLPP capabilities, SLPP resources, and/or SLPP service requirements for the UE. The one or more processors 1002 may be configured, for example, to transmit and receive, via the external interface, proposed PRS configurations for sidelink positioning and may be configured to transmit and receive, via the external interface, confirmation, rejection or modification of proposed PRS configurations for sidelink positioning. The sidelink positioning messages may use SLPP as discussed herein. The one or more processors 1002 may be configured, for example, to transmit and receive, via the external interface, SLPP messages that include a measurement report or location results. The transmitted measurement report, for example, may include information for the sidelink positioning signals transmitted by the UE and measurements performed by the UE 1000 for sidelink positioning signals transmitted by other UEs and may include indications of reverse link communication from each UE in a group to the UE 1000. The received measurement reports, for example, may include measurements performed by other UEs including measurements for the sidelink positioning signals transmitted by the UE 1000, and may include indications of reverse link communication from each UE in a group to each of the other UEs in the group. The location results may include ranges, distances and/or directions between one or more pairs of UEs in a group and/or relative locations, absolute locations and/or velocities and/or relative velocities for each of one or more UEs in a group.

The medium 1020 and/or memory 1004 may include a PRS module 1023 that when implemented by the one or more processors 1002 configures the one or more processors 1002 to transmit, via the external interface including one or more of wireless transceivers 1010, 1011, 1012, and 1013, PRS for sidelink positioning (e.g. sidelink PRS or sidelink SRS for NR or LTE). The one or more processors 1002 may be configured to transmit the SL PRS consistent with a proposed SL PRS configuration sent to or received from another UE. The one or more processors 1002 may be further configured to receive SL PRS from other UEs, via the external interface, and to measure the SL PRS for sidelink positioning.

The medium 1020 and/or memory 1004 may include a location module 1024 that when implemented by the one or more processors 1002 configures the one or more processors 1002 to determine location results for one or more UEs with respect to the UE 1000 based on SL PRS measurements performed by the UE 1000 and measurement information received in SLPP messages from the other UEs. The one or more processors 1002 may be further configured to determine velocities of the UE 1000 and/or other UEs based SL PRS measurements performed by the UE 1000, and measurement information received in SLPP messages from the other UEs.

The medium 1020 and/or memory 1004 may include a discovery module 1026 that when implemented by the one or more processors 1002 configures the one or more processors 1002 to discover one or more other UEs that are available for sidelink positioning. The one or more processors 1002 may be further configured to obtain group criteria parameters for other UEs, such as a distance restriction, a time restriction, a direction of travel restriction, a speed restriction, sidelink position method restriction or a sidelink position method type restriction.

The medium 1020 and/or memory 1004 may include a group management module 1028 that when implemented by the one or more processors 1002 configures the one or more processors 1002 to determine a group status indication for one or more UEs, indicating inclusion or exclusion of the UE in the group, based on the group criteria parameters. The one or more processors 1002 may be further configured to determine a group status indication for one or more UEs in a group, indicating inclusion or exclusion of the UE in the group, based on the indications of reverse link communication for the one or more UEs, including indications of reverse link communication from each UE and the indications of reverse link communication from the UE 1000. The one or more processors 1002 may be further configured to determine a status of forward link communication and a status of reverse link communication between all pairs of UEs in the group based on the indications of reverse link communication from each UE in the group. The one or more processors 1002 may be further configured to determine the group status indication for one or more UEs based on the status of the forward link communication and the status of the reverse link communication between all pairs of UEs in the group. The one or more processors 1002 may be further configured to instigate the addition or transfer of one or more UEs from one group to another group based on relative locations and velocities of the one or more UEs and the UEs in the groups.

The methodologies described herein may be implemented by various means depending upon the application. For example, these methodologies may be implemented in hardware, firmware, software, or any combination thereof. For a hardware implementation, the one or more processors 1002 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a non-transitory computer readable medium 1020 or memory 1004 that is connected to and executed by the one or more processors 1002. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 1008 on a non-transitory computer readable medium, such as medium 1020 and/or memory 1004. Examples include computer readable media encoded with a data structure and computer readable media encoded with a computer program code 1008. For example, the non-transitory computer readable medium including program code 1008 stored thereon may include program code 1008 to support sidelink positioning in a manner consistent with disclosed embodiments. Non-transitory computer readable medium 1020 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 1008 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 1020, instructions and/or data may be provided as signals on transmission media included in a communication apparatus. For example, a communication apparatus may include an external interface including one or more of wireless transceivers 1010, 1011, 1012, and 1013 having signals indicative of instructions and data. The instructions and data are configured to cause one or more processors to implement the functions outlined in the claims. That is, the communication apparatus includes transmission media with signals indicative of information to perform disclosed functions.

Memory 1004 may represent any data storage mechanism. Memory 1004 may include, for example, a primary memory and/or a secondary memory. Primary memory may include, for example, a random-access memory, read only memory, etc. While illustrated in this example as being separate from one or more processors 1002, it should be understood that all or part of a primary memory may be provided within or otherwise co-located/coupled with the one or more processors 1002. Secondary memory may include, for example, the same or similar type of memory as primary memory and/or one or more data storage devices or systems, such as, for example, a disk drive, an optical disc drive, a tape drive, a solid-state memory drive, etc.

In certain implementations, secondary memory may be operatively receptive of, or otherwise configurable to couple to a non-transitory computer readable medium 1020. As such, in certain example implementations, the methods and/or apparatuses presented herein may take the form in whole or part of a computer readable medium 1020 that may include computer implementable program code 1008 stored thereon, which if executed by one or more processors 1002 may be operatively enabled to perform all or portions of the example operations as described herein. Computer readable medium 1020 may be a part of memory 1004.

FIG. 11 shows a schematic block diagram illustrating certain exemplary features of a location server 1100, e.g., which may be LMF 120, SUPL SLP 119 or server 121 or 123 shown in FIG. 1A, or LMF 120a or 120b or SUPL SLP 119a or 119b or server 121a, 121b or 123 shown in FIG. 2 or location server 302 shown in FIG. 3, and supports network supported sidelink positioning, as described herein. The location server 1100, for example, may be an LMF or a SUPL SLP (Secure User Plane Location (SUPL) Location Platform). The location server 1100, for example, may perform the signal flow 300 shown in FIG. 3 and accompanying techniques as discussed herein. In some instances, the location server 1100 may comprise a coordinating entity that may receive resource capability maps and/or resource usage maps from UEs participating in SL positioning, as described herein. The location server 1100 may include, for example, one or more processors 1102 and memory 1104, an external interface 1110, which may be operatively coupled with one or more connections 1106 (e.g., buses, lines, fibers, links, etc.) to non-transitory computer readable medium 1120 and memory 1104. The external interface 1110 may be a wired and/or wireless interface capable of connecting to network entities in the core network 140, such as an AMF or UPF, through which the location server 1100 may communicate with RAN nodes and UEs. The location server 1100 may further include additional items, which are not shown, such as a user interface that may include e.g., a display, a keypad or other input device, such as virtual keypad on the display, through which a user may interface with the location server. In certain example implementations, all or part of location server 1100 may take the form of a chipset, and/or the like.

The one or more processors 1102 may be implemented using a combination of hardware, firmware, and software. For example, the one or more processors 1102 may be configured to perform the functions discussed herein by implementing one or more instructions or program code 1108 on a non-transitory computer readable medium, such as medium 1120 and/or memory 1104. In some embodiments, the one or more processors 1102 may represent one or more circuits configurable to perform at least a portion of a data signal computing procedure or process related to the operation of location server 1100.

The medium 1120 and/or memory 1104 may store instructions or program code 1108 that contain executable code or software instructions that when executed by the one or more processors 1102 cause the one or more processors 1102 to operate as a special purpose computer programmed to perform the techniques disclosed herein. As illustrated in location server 1100, the medium 1120 and/or memory 1104 may include one or more components or modules that may be implemented by the one or more processors 1102 to perform the methodologies described herein. While the components or modules are illustrated as software in medium 1120 that is executable by the one or more processors 1102, it should be understood that the components or modules may be stored in memory 1104 or may be dedicated hardware either in the one or more processors 1102 or off the processors.

A number of software modules and data tables may reside in the medium 1120 and/or memory 1104 and be utilized by the one or more processors 1102 in order to manage both communications and the functionality described herein. It should be appreciated that the organization of the contents of the medium 1120 and/or memory 1104 as shown in location server 1100 is merely exemplary, and as such the functionality of the modules and/or data structures may be combined, separated, and/or be structured in different ways depending upon the implementation of the location server 1100.

The medium 1120 and/or memory 1104 may include an SLPP message module 1122 that when implemented by the one or more processors 1102 configures the one or more processors 1102 to send and receive SLPP messages to and from UEs, via the external interface 1110. The sidelink positioning messages may use SLPP as discussed herein. The one or more processors 1102 may be configured to transmit and receive SLPP messages, via the external interface 1110, not embedded in an LPP message, embedded in an LPP message, embedded in a SUPL message (which may include a SUPL POS message), or embedded in both an LPP and SUPL message (which may include a SUPL POS message). The one or more processors 1102 may be configured, for example, to transmit and receive, via the external interface 1110, SLPP messages that include an SLPP capabilities request or SLPP capabilities, SLPP resources, and/or SLPP service requirements for the UE. The one or more processors 1102 may be configured, for example, to transmit and receive, via the external interface 1110, proposed SL PRS configurations for sidelink positioning and may be configured to transmit and receive, via the external interface 1110, confirmation, rejection or modification of proposed SL PRS configurations for sidelink positioning. The one or more processors 1102 may be configured, for example, to transmit and receive, via the external interface 1110, SLPP messages that include a measurement report or location results. A measurement report, for example, may include measurements performed by UEs including measurements for sidelink positioning signals transmitted by UEs, and may include indications of reverse link communication from each UE in a group to each of the other UEs in the group. The location results may include ranges, distances and/or directions between one or more pairs of UEs in a group and/or relative locations, absolute locations and/or velocities for each of one or more UEs in a group.

The medium 1120 and/or memory 1104 may include an SL PRS configuration module 1123 that when implemented by the one or more processors 1102 configures the one or more processors 1102 to generate or verify configurations for SL PRS to be transmitted by one or more UEs for sidelink positioning. The one or more processors 1102 may be configured, for example, to obtain SLPP capabilities, SLPP resources, and SLPP service requirements for one or more UEs. The one or more processors 1102 may be configured to obtain SL PRS configurations for UEs.

The medium 1120 and/or memory 1104 may include a location module 1124 that when implemented by the one or more processors 1102 configures the one or more processors 1102 to determine location results for one or more UEs based on SL PRS measurements performed by the UEs. The one or more processors 1102 may be further configured to determine velocities of the UEs based SL PRS measurements performed by the UEs. The one or more processors 1102 may be further configured to send to UEs, via the external interface 1110, the location results, such as ranges, directions, relative locations and/or velocities for the UEs.

The methodologies described herein may be implemented by various means depending upon the application. For example, these methodologies may be implemented in hardware, firmware, software, or any combination thereof. For a hardware implementation, the one or more processors 1102 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 1120 or memory 1104 that is connected to and executed by the one or more processors 1102. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 1108 on a non-transitory computer readable medium, such as medium 1120 and/or memory 1104. Examples include computer readable media encoded with a data structure and computer readable media encoded with a computer program code 1108. For example, the non-transitory computer readable medium including program code 1108 stored thereon may include program code 1108 to enable network supported sidelink positioning in a manner consistent with disclosed embodiments. Non-transitory computer readable medium 1120 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 1108 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 1120, instructions and/or data may be provided as signals on transmission media included in a communication apparatus. For example, a communication apparatus may include an external interface 1110 having signals indicative of instructions and data. The instructions and data are configured to cause one or more processors to implement the functions outlined in the claims. That is, the communication apparatus includes transmission media with signals indicative of information to perform disclosed functions.

Memory 1104 may represent any data storage mechanism. Memory 1104 may include, for example, a primary memory and/or a secondary memory. Primary memory may include, for example, a random access memory, read only memory, etc. While illustrated in this example as being separate from one or more processors 1102, it should be understood that all or part of a primary memory may be provided within or otherwise co-located/coupled with the one or more processors 1102. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 1120. As such, in certain example implementations, the methods and/or apparatuses presented herein may take the form in whole or part of a computer readable medium 1120 that may include computer implementable program code 1108 stored thereon, which if executed by one or more processors 1102 may be operatively enabled to perform all or portions of the example operations as described herein. Computer readable medium 1120 may be a part of memory 1104.

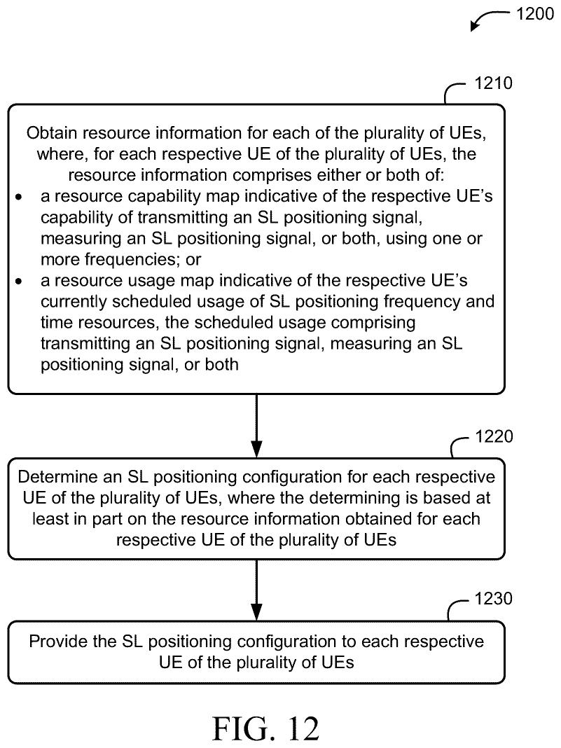

FIG. 12 is a flow diagram of a method 1200 performed by a coordinating entity for supporting sidelink (SL) positioning of a plurality of UEs (e.g. UEs 105), according to an embodiment. Some or all of the functionality illustrated in the blocks of FIG. 12 may be performed by a coordinating entity, such as a UE (e.g. a UE 105 or UE 1000) or server (e.g. LMF 120 or location server 1100), as described herein. Thus, means and/or structure for performing this functionality may comprise one or more components of a UE, as illustrated in FIG. 10 and described above, and/or components of a location server, as illustrated in FIG. 11 and described above.

The various functions of the method 1200 are as follows. The functionality at block 1210 comprises obtaining resource information for each of the plurality of UEs, wherein, for each respective UE of the plurality of UEs, the resource information comprises either or both of (i) a resource capability map indicative of the respective UE's capability of transmitting an SL positioning signal, measuring an SL positioning signal, or both, using one or more frequencies; or (ii) a resource usage map indicative of the respective UE's currently scheduled usage of SL positioning frequency and time resources, the scheduled usage comprising transmitting an SL positioning signal, measuring an SL positioning signal, or both. Embodiments may include obtaining a resource capability map and/or a resource usage map as described above with respect to FIGS. 8 and 9, for example. Moreover, this resource information may be provided during an exchange of capabilities, as described herein and illustrated in FIGS. 5-7, for example. Means and/or structure for performing the functionality at block 1210 may comprise one or more components of a UE, such as one or more processors 1002, memory 1004, connection(s) 1006, WWAN transceiver 1010, WLAN transceiver 1011, medium 1020, and/or other components of a UE 1000 as illustrated in FIG. 10 and described above. Additionally, or alternatively, means and/or structure for performing the functionality at block 1210 may comprise one or more components of a location server, such as one or more processors 1102, memory 1104, one or more connections 1106, external interface 1110, medium 1120, and/or other components of a location server 1100 as illustrated in FIG. 11 and described above.

Functionality at block 1220 comprises determining an SL positioning configuration for each respective UE of the plurality of UEs, wherein the determining is based at least in part on the resource information obtained for each respective UE of the plurality of UEs. Means and/or structure for performing the functionality at block 1220 may comprise one or more components of a UE, such as one or more processors 1002, memory 1004, connection(s) 1006, medium 1020, and/or other components of a UE 1000 as illustrated in FIG. 10 and described above. Additionally, or alternatively, means and/or structure for performing the functionality at block 1220 may comprise one or more components of a location server, such as one or more processors 1102, memory 1104, one or more connections 1106, external interface 1110, medium 1120, and/or other components of a location server 1100 as illustrated in FIG. 11 and described above.

The functionality at block 1230 comprises providing the SL positioning configuration to each respective UE of the plurality of UEs. It will be appreciated by a person of ordinary skill in the art that different embodiments may implement variations to the method 1200, as described in the embodiments detailed above. As noted herein, the SL positioning configuration may be provided and/or confirmed by a coordinating entity, as described above with respect to FIGS. 5-7, for example. Means and/or structure for performing the functionality at block 1230 may comprise one or more components of a UE, such as one or more processors 1002, memory 1004, connection(s) 1006, WWAN transceiver 1010, WLAN transceiver 1011, medium 1020, and/or other components of a UE 1000 as illustrated in FIG. 10 and described above. Additionally, or alternatively, means and/or structure for performing the functionality at block 1230 may comprise one or more components of a location server, such as one or more processors 1102, memory 1104, one or more connections 1106, external interface 1110, medium 1120, and/or other components of a location server 1100 as illustrated in FIG. 11 and described above.

As noted herein, embodiments of the method performed by a coordinating entity for supporting SL positioning of a plurality of UEs, including the method 1200, may include one or more additional features. For example, in embodiments in which the resource information comprises the resource capability map, the one or more frequencies may be quantized using resource blocks or resource elements of an orthogonal frequency-division multiplexing (OFDM) communication scheme such as 4G LTE or 5G NR. For embodiments in which the resource information comprises the resource usage map, the SL positioning frequency and time resources may be quantized using resource blocks or resource elements of an OFDM communication scheme such as 4G LTE or 5G NR. For embodiments in which the resource information comprises the resource capability map, the resource information may further comprise one or more resource parameters indicative of: a bandwidth, coding, duration, periodicity, or any combination thereof, with which the respective UE is capable of transmitting SL positioning signals; a bandwidth, coding, duration, periodicity, or any combination thereof, with which the respective UE is capable of measuring the SL positioning signals; a capability of the respective UE to perform simultaneous measurements of multiple SL positioning signals; or any combination thereof. Additionally or alternatively, for embodiments in which the resource information comprises the resource usage map, the resource information may further comprise one or more resource parameters indicative of: a bandwidth, coding, duration, periodicity, or any combination thereof, with which the respective UE is configured to transmit SL positioning signals; a bandwidth, coding, duration, periodicity, or any combination thereof, with which the respective UE is configured to measure the SL positioning signals; or any combination thereof. According to some embodiments, the resource information may further comprise an indication of an average level of background RF activity (e.g. RF transmission) from other entities at each frequency of a plurality of frequencies.

Additionally, or alternatively, embodiments of the method 1200 may include one or more of the following features. As previously noted, according to some embodiments, the coordinating entity may comprise a coordinating UE or a location server. For embodiments in which the coordinating entity comprises the coordinating UE, the plurality of UEs may include the coordinating UE. According to some embodiments in which the resource information comprises the resource usage map, time information included in the resource usage map may include only information corresponding to SL positioning occasions, e.g. as described for FIG. 9. According to some embodiments, the SL positioning configuration for each respective UE in the plurality of UEs may comprise: an SL PRS configuration to be transmitted by the respective UE; a plurality of SL PRS configurations to be measured by the respective UE, wherein each SL PRS configuration in the plurality of SL PRS configurations is transmitted by some other UE in the plurality of UEs; or both of these. Additionally or alternatively, obtaining the resource information for each of the plurality of UEs may comprise receiving the resource information from each of the plurality of UEs, that is not the coordinating entity, in an SLPP message. According to some embodiments, providing the SL positioning configuration to each respective UE of the plurality of UEs may comprise sending the resource information to the respective UE in an SLPP message, when the respective UE is not the coordinating entity.

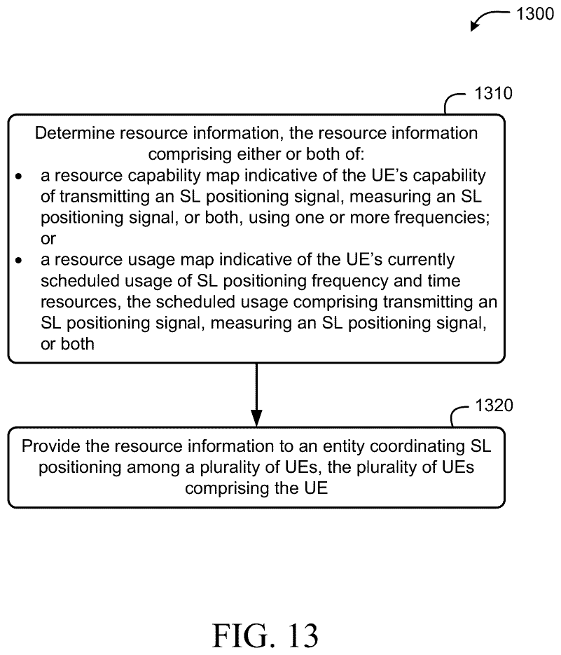

FIG. 13 is a flow diagram of a method 1300 performed by a UE (e.g. a UE 105 or UE 1000) for sidelink (SL) positioning, according to an embodiment. Some or all of the functionality illustrated in the blocks of FIG. 13 may be performed by a UE, as described herein. Thus, means and/or structure for performing this functionality may comprise one or more components of a UE, as illustrated in FIG. 10 and described above.

The various functions of the method 1300 are as follows. The functionality at block 1310 comprises determining resource information, the resource information comprising either or both of: (i) a resource capability map indicative of the UE's capability of transmitting an SL positioning signal, measuring an SL positioning signal, or both, using one or more frequencies; or (ii) a resource usage map indicative of the UE's currently scheduled usage of SL positioning frequency and time resources, the scheduled usage comprising transmitting an SL positioning signal, measuring an SL positioning signal, or both. A resource capability map and/or a resource usage map as used in the method 1300 may correspond to those described above with respect to FIGS. 8 and 9, for example. Means and/or structure for performing the functionality at block 1310 may comprise one or more components of a UE, such as one or more processors 1002, memory 1004, connection(s) 1006, medium 1020, and/or other components of a UE 1000 as illustrated in FIG. 10 and described above.

The functionality at block 1320 comprises providing the resource information to an entity coordinating SL positioning among a plurality of UEs, the plurality of UEs comprising the UE. Again, it will be appreciated by a person of ordinary skill in the art that different embodiments may implement variations to the method 1300, as described in the embodiments detailed above. As indicated in the embodiments described above, this resource information may be provided during a capabilities exchange, as described herein and illustrated in FIGS. 5-7. Means and/or structure for performing the functionality at block 1320 may comprise one or more components of a UE, such as one or more processors 1002, memory 1004, connection(s) 1006, WWAN transceiver 1010, WLAN transceiver 1011, medium 1020, and/or other components of a UE 1000 as illustrated in FIG. 10 and described above.

As noted herein, embodiments of a method performed by a UE for SL positioning, including the method 1300, may include one or more additional features. For example, in embodiments in which the resource information comprises the resource capability map, the one or more frequencies may be quantized using resource blocks or resource elements of an orthogonal frequency-division multiplexing (OFDM) communication scheme, such as 4G LTE or 5G NR. Additionally, or alternatively, for embodiments in which the resource information comprises the resource usage map, the SL positioning frequency and time resources may be quantized using resource blocks or resource elements of an OFDM communication scheme, such as 4G LTE or 5G NR. For embodiments in which the resource information comprises the resource capability map, the resource information may further comprise one or more resource parameters indicative of: a bandwidth, coding, duration, periodicity, or any combination thereof, with which the UE is capable of transmitting SL positioning signals; a bandwidth, coding, duration, periodicity, or any combination thereof, with which the UE is capable of measuring SL positioning signals; a capability of the UE to perform simultaneous measurements of multiple SL positioning signals; or any combination thereof. For embodiments in which the resource information comprises the resource usage map, the resource information may further comprise one or more resource parameters indicative of: a bandwidth, coding, duration, periodicity, or any combination thereof, with which the UE is configured to transmit SL positioning signals; a bandwidth, coding, duration, periodicity, or any combination thereof, with which the UE is configured to measure SL positioning signals; or any combination thereof. According to some embodiments, the resource information may further comprise an indication of an average level of background radio frequency (RF) activity from other entities at each frequency of a plurality of frequencies, as detected by the UE.

Additionally, or alternatively, embodiments of the method 1300 may include one or more of the following features. The entity coordinating the SL positioning among the plurality of UEs may comprise a coordinating UE or a location server (e.g. an LMF 120). In such embodiments, the entity coordinating the SL positioning among the plurality of UEs may comprise the coordinating UE, wherein the UE may comprise the coordinating UE. For embodiments in which the resource information comprises the resource usage map, time information included in the resource usage map may include only information corresponding to SL positioning occasions, e.g. as described for FIG. 9. Additionally, or alternatively, providing the resource information to the entity coordinating SL positioning among the plurality of UEs may comprise sending the resource information to the entity coordinating SL positioning among the plurality of UEs in an SLPP message when the UE is not the entity coordinating SL positioning among the plurality of UEs.

Some embodiments of the method 1300 may further comprise obtaining an SL positioning configuration from the entity coordinating SL positioning among the plurality of UEs, where the SL positioning configuration is based at least in part on the resource information. According to some embodiments, obtaining the SL positioning configuration from the entity coordinating SL positioning among the plurality of UEs may comprise receiving the SL positioning configuration from the entity coordinating SL positioning among the plurality of UEs in an SLPP message when the UE is not the entity coordinating SL positioning among the plurality of UEs. Additionally, or alternatively, the SL positioning configuration may comprise an SL PRS configuration to be transmitted by the UE; or a plurality of SL PRS configurations to be measured by the UE, wherein each SL PRS configuration in the plurality of SL PRS configurations is transmitted by some other UE in the plurality of UEs; or both of these.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method performed by a coordinating entity for supporting sidelink (SL) positioning of a plurality of user equipments (UEs), the method comprising: obtaining resource information for each of the plurality of UEs, wherein, for each respective UE of the plurality of UEs, the resource information comprises either or both of: a resource capability map indicative of the respective UE's capability of transmitting an SL positioning signal, measuring an SL positioning signal, or both, using one or more frequencies; or a resource usage map indicative of the respective UE's currently scheduled usage of SL positioning frequency and time resources, the scheduled usage comprising transmitting an SL positioning signal, measuring an SL positioning signal, or both; determining an SL positioning configuration for each respective UE of the plurality of UEs, wherein the determining is based at least in part on the resource information obtained for each respective UE of the plurality of UEs; and providing the SL positioning configuration to each respective UE of the plurality of UEs.

Clause 2: The method of clause 1, wherein the resource information comprises the resource capability map, and the one or more frequencies are quantized using resource blocks or resource elements of an orthogonal frequency-division multiplexing (OFDM) communication scheme.

Clause 3: The method of either of clauses 1 or 2, wherein the resource information comprises the resource usage map, and the SL positioning frequency and time resources are quantized using resource blocks or resource elements of an OFDM communication scheme.

Clause 4: The method of any one of clauses 1-3, wherein the resource information comprises the resource capability map, and wherein the resource information further comprises one or more resource parameters indicative of: a bandwidth, coding, duration, periodicity, or any combination thereof, with which the respective UE is capable of transmitting SL positioning signals; a bandwidth, coding, duration, periodicity, or any combination thereof, with which the respective UE is capable of measuring the SL positioning signals; a capability of the respective UE to perform simultaneous measurements of multiple SL positioning signals; or any combination thereof.

Clause 5: The method of any one of clauses 1-4, wherein the resource information comprises the resource usage map, and wherein the resource information further comprises one or more resource parameters indicative of: a bandwidth, coding, duration, periodicity, or any combination thereof, with which the respective UE is configured to transmit SL positioning signals; a bandwidth, coding, duration, periodicity, or any combination thereof, with which the respective UE is configured to measure the SL positioning signals; or any combination thereof.

Clause 6: The method of any one of clauses 1-5, wherein the resource information further comprises an indication of an average level of background radio frequency (RF) activity from other entities at each frequency of a plurality of frequencies.

Clause 7: The method of any one of clauses 1-6, wherein the coordinating entity comprises a coordinating UE or a location server.

Clause 8: The method of clause 7, wherein the coordinating entity comprises the coordinating UE, and wherein the plurality of UEs includes the coordinating UE.

Clause 9: The method of any one of clauses 1-8, wherein the resource information comprises the resource usage map, and wherein time information included in the resource usage map includes only information corresponding to SL positioning occasions.

Clause 10: The method of any one of clauses 1-9, wherein the SL positioning configuration for each respective UE in the plurality of UEs comprises: an SL Positioning Reference Signal (PRS) configuration to be transmitted by the respective UE; a plurality of SL PRS configurations to be measured by the respective UE, wherein each SL PRS configuration in the plurality of SL PRS configurations is transmitted by some other UE in the plurality of UEs; or both of these.

Clause 11: The method of any one of clauses 1-10, wherein obtaining the resource information for each of the plurality of UEs comprises receiving the resource information from each of the plurality of UEs, that is not the coordinating entity, in a Sidelink Positioning Protocol (SLPP) message.

Clause 12: The method of any one of clauses 1-11, wherein providing the SL positioning configuration to each respective UE of the plurality of UEs comprises sending the resource information to the respective UE in a Sidelink Positioning Protocol (SLPP) message, when the respective UE is not the coordinating entity.

Clause 13: A method performed by a user equipment (UE) for sidelink (SL) positioning, the method comprising: determining resource information, the resource information comprising either or both of: a resource capability map indicative of the UE's capability of transmitting an SL positioning signal, measuring an SL positioning signal, or both, using one or more frequencies; or a resource usage map indicative of the UE's currently scheduled usage of SL positioning frequency and time resources, the scheduled usage comprising transmitting an SL positioning signal, measuring an SL positioning signal, or both; and providing the resource information to an entity coordinating SL positioning among a plurality of UEs, the plurality of UEs including the UE.

Clause 14: The method of clause 13, wherein the resource information comprises the resource capability map, and the one or more frequencies are quantized using resource blocks or resource elements of an orthogonal frequency-division multiplexing (OFDM) communication scheme.

Clause 15: The method of either of clauses 13 or 14, wherein the resource information comprises the resource usage map, and the SL positioning frequency and time resources are quantized using resource blocks or resource elements of an OFDM communication scheme.

Clause 16: The method of any one of clauses 13-15, wherein the resource information comprises the resource capability map, and wherein the resource information further comprises one or more resource parameters indicative of: a bandwidth, coding, duration, periodicity, or any combination thereof, with which the UE is capable of transmitting SL positioning signals; a bandwidth, coding, duration, periodicity, or any combination thereof, with which the UE is capable of measuring SL positioning signals; a capability of the UE to perform simultaneous measurements of multiple SL positioning signals; or any combination thereof.

Clause 17: The method of any one of clauses 13-16, wherein the resource information comprises the resource usage map, and wherein the resource information further comprises one or more resource parameters indicative of: a bandwidth, coding, duration, periodicity, or any combination thereof, with which the UE is configured to transmit SL positioning signals; a bandwidth, coding, duration, periodicity, or any combination thereof, with which the UE is configured to measure SL positioning signals; or any combination thereof.

Clause 18: The method of any one of clauses 13-17, wherein the resource information further comprises an indication of an average level of background radio frequency (RF) activity from other entities at each frequency of a plurality of frequencies, as detected by the UE.

Clause 19: The method of any one of clauses 13-18, wherein the entity coordinating the SL positioning among the plurality of UEs comprises a coordinating UE or a location server.

Clause 20: The method of clause 19, wherein the entity coordinating the SL positioning among the plurality of UEs comprises the coordinating UE, wherein the UE comprises the coordinating UE.

Clause 21: The method of any one of clauses 13-20, wherein the resource information comprises the resource usage map, and wherein time information included in the resource usage map includes only information corresponding to SL positioning occasions.

Clause 22: The method of any one of clauses 13-21, wherein providing the resource information to the entity coordinating SL positioning among the plurality of UEs comprises sending the resource information to the entity coordinating SL positioning among the plurality of UEs in an SLPP message when the UE is not the entity coordinating SL positioning among the plurality of UEs.

Clause 23: The method of any one of clauses 13-22, further comprising obtaining an SL positioning configuration from the entity coordinating SL positioning among the plurality of UEs, wherein the SL positioning configuration is based at least in part on the resource information.

Clause 24: The method of clause 23, wherein obtaining the SL positioning configuration from the entity coordinating SL positioning among the plurality of UEs comprises receiving the resource information from the entity coordinating SL positioning among the plurality of UEs in an SLPP message when the UE is not the entity coordinating SL positioning among the plurality of UEs.

Clause 25: The method of any one of clauses 23-24, wherein the SL positioning configuration comprises: an SL PRS configuration to be transmitted by the UE; or a plurality of SL PRS configurations to be measured by the UE, wherein each SL PRS configuration in the plurality of SL PRS configurations is transmitted by some other UE in the plurality of UEs; or both of these.

Clause 26: A coordinating entity comprising: at least one transceiver; at least one memory; and at least one processor communicatively coupled with the at least one transceiver and at least one memory, the at least one processor configured to: obtain resource information for each of a plurality of user equipments (UEs), wherein, for each respective UE of the plurality of UEs, the resource information comprises either or both of: a resource capability map indicative of the respective UE's capability of transmitting a sidelink (SL) positioning signal, measuring an SL positioning signal, or both, using one or more frequencies; or a resource usage map indicative of the respective UE's currently scheduled usage of SL position frequency and time resources, the scheduled usage comprising transmitting an SL positioning signal, measuring an SL positioning signal, or both; determine an SL positioning configuration for each respective UE of the plurality of UEs, wherein the determining is based at least in part on the resource information obtained for each respective UE of the plurality of UEs; and provide the SL positioning configuration via the at least one transceiver to each respective UE of the plurality of UEs.

Clause 27: The coordinating entity of clause 26, wherein, to obtain the resource information comprising the resource capability map, the at least one processor is configured to obtain information in which the one or more frequencies are quantized using resource blocks or resource elements of an orthogonal frequency-division multiplexing (OFDM) communication scheme.

Clause 28: The coordinating entity of either of clauses 26 or 27, wherein, to obtain the resource information comprising the resource usage map, the at least one processor is configured to obtain information in which the SL positioning frequency and time resources are quantized using resource blocks or resource elements of an OFDM communication scheme.

Clause 29: The coordinating entity of any one of clauses 26-28, wherein the at least one processor is configured to obtain one or more resource parameters in the resource information when the resource information comprises the resource capability map, the one or more resource parameters indicative of: a bandwidth, coding, duration, periodicity, or any combination thereof, with which the respective UE is capable of transmitting SL positioning signals; a bandwidth, coding, duration, periodicity, or any combination thereof, with which the respective UE is capable of measuring the SL positioning signals; a capability of the respective UE to perform simultaneous measurements of multiple SL positioning signals; or any combination thereof.

Clause 30: The coordinating entity of any one of clauses 26-29, wherein the at least one processor is configured to obtain one or more resource parameters in the resource information when the resource information comprises the resource usage map, the one or more resource parameters indicative of: a bandwidth, coding, duration, periodicity, or any combination thereof, with which the respective UE is configured to transmit SL positioning signals; a bandwidth, coding, duration, periodicity, or any combination thereof, with which the respective UE is configured to measure the SL positioning signals; or any combination thereof.

Clause 31: The coordinating entity of any one of clauses 26-30, wherein the at least one processor is configured to obtain, from the resource information, an indication of an average level of background radio frequency (RF) activity from other entities at each frequency of a plurality of frequencies.

Clause 32: The coordinating entity of any one of clauses 26-31, wherein the coordinating entity comprises a coordinating UE or a location server.

Clause 33: The coordinating entity of any one of clauses 26-32, wherein the at least one processor is configured to obtain time information included in the resource usage map that includes only information corresponding to SL positioning occasions when the resource information comprises the resource usage map.

Clause 34: The coordinating entity of any one of clauses 26-33, wherein the processor, when the SL positioning configuration for each respective UE in the plurality of UEs, is configured to: an SL PRS configuration to be transmitted by the respective UE; a plurality of SL PRS configurations to be measured by the respective UE, wherein each SL PRS configuration in the plurality of SL PRS configurations is transmitted by some other UE in the plurality of UEs; or both of these.

Clause 35: The coordinating entity of any one of clauses 26-34, wherein, to obtain the resource information for each of the plurality of UEs, the at least one processor is configured to receive the resource information from each of the plurality of UEs, that is not the coordinating entity, in an SLPP message.

Clause 36: The coordinating entity of any one of clauses 26-35, wherein, to provide the SL positioning configuration to each respective UE of the plurality of UEs, the at least one processor is configured to send the resource information to the respective UE in an SLPP message, when the respective UE is not the coordinating entity.

Clause 37: A user equipment (UE) comprising: at least one transceiver; at least one memory; and at least one processor communicatively coupled with the at least one transceiver and at least one memory, the at least one processor configured to: determine resource information, the resource information comprising either or both of: a resource capability map indicative of the UE's capability of transmitting a sidelink (SL) positioning signal, measuring an SL positioning signal, or both, using one or more frequencies; a resource usage map indicative of the UE's currently scheduled usage of SL position frequency and time resources, the scheduled usage comprising transmitting an SL positioning signal, measuring an SL positioning signal, or both; and provide the resource information via the at least one transceiver to an entity coordinating SL positioning among a plurality of UEs, the plurality of UEs including the UE.

Clause 38: The UE of clause 37, wherein, to provide the resource information comprising the resource capability map, the at least one processor is configured to quantize to and the one or more frequencies using resource blocks or resource elements of an orthogonal frequency-division multiplexing (OFDM) communication scheme.

Clause 39: The UE of either of clauses 37 or 38, wherein, to provide the resource information comprising the resource usage map, the at least one processor is configured to quantize the SL positioning frequency and time resources using resource blocks or resource elements of an OFDM communication scheme.

Clause 40: The UE of any one of clauses 37-39, wherein, when the resource information comprises the resource capability map, the at least one processor is configured to include, in the resource information, one or more resource parameters indicative of: a bandwidth, coding, duration, periodicity, or any combination thereof, with which the UE is capable of transmitting SL positioning signals; a bandwidth, coding, duration, periodicity, or any combination thereof, with which the UE is capable of measuring SL positioning signals; a capability of the UE to perform simultaneous measurements of multiple SL positioning signals; or any combination thereof.

Clause 41: The UE of any one of clauses 37-40, wherein, when the resource information comprises the resource usage map, the at least one processor is configured to include, in the resource information, one or more resource parameters indicative of: a bandwidth, coding, duration, periodicity, or any combination thereof, with which the UE is configured to transmit SL positioning signals; a bandwidth, coding, duration, periodicity, or any combination thereof, with which the UE is configured to measure SL positioning signals; or any combination thereof.

Clause 42: The UE of any one of clauses 37-41, wherein the at least one processor is configured to include, in the resource information, an indication of an average level of background radio frequency (RF) activity from other entities at each frequency of a plurality of frequencies, as detected by the UE.

Clause 43: The UE of any one of clauses 37-42, wherein, when the resource information comprises the resource usage map, the at least one processor is configured to include time information in the resource usage map that includes only information corresponding to SL positioning occasions.

Clause 44: The UE of any one of clauses 37-43, wherein, to provide the resource information to the entity coordinating SL positioning among the plurality of UEs, the at least one processor is configured to send the resource information to the entity coordinating SL positioning among the plurality of UEs in an SLPP message when the UE is not the entity coordinating SL positioning among the plurality of UEs.

Clause 45: The UE of any one of clauses 37-44, wherein the at least one processor is further configured to obtain an SL positioning configuration from the entity coordinating SL positioning among the plurality of UEs, wherein the SL positioning configuration is based at least in part on the resource information.

Clause 46: The UE of clause 45, wherein, to obtain the SL positioning configuration from the entity coordinating SL positioning among the plurality of UEs, the at least one processor is configured to receive the resource information from the entity coordinating SL positioning among the plurality of UEs in an SLPP message when the UE is not the entity coordinating SL positioning among the plurality of UEs.

Clause 47: The UE of any one of clauses 45-46, wherein, to obtain the SL positioning configuration, the at least one processor is configured to obtain: an SL PRS configuration to be transmitted by the UE; or a plurality of SL PRS configurations to be measured by the UE, wherein each SL PRS configuration in the plurality of SL PRS configurations is transmitted by some other UE in the plurality of UEs; or both of these.

Clause 48: An apparatus having means for performing the method of any one of clauses 1-25.

Clause 49: A non-transitory computer-readable medium storing instructions, the instructions comprising code for performing the method of any one of clauses 1-25.

What is claimed is:

1. A method performed by a coordinating entity for supporting sidelink (SL) positioning of a plurality of user equipments (UEs), the method comprising:
obtaining resource information for each of the plurality of UEs, wherein, for each respective UE of the plurality of UEs, the resource information comprises either or both of:
a resource capability map indicative of the respective UE's capability of transmitting an SL positioning signal, measuring an SL positioning signal, or both, using one or more frequencies; or
a resource usage map indicative of the respective UE's currently scheduled usage of SL positioning frequency and time resources, the scheduled usage comprising transmitting an SL positioning signal, measuring an SL positioning signal, or both;
determining an SL positioning configuration for each respective UE of the plurality of UEs, wherein the determining is based at least in part on the resource information obtained for each respective UE of the plurality of UEs; and
providing the SL positioning configuration to each respective UE of the plurality of UEs.

2. The method of claim 1, wherein the resource information comprises the resource capability map, and the one or more frequencies are quantized using resource blocks or resource elements of an orthogonal frequency-division multiplexing (OFDM) communication scheme.

3. The method of claim 1, wherein the resource information comprises the resource usage map, and the SL positioning frequency and time resources are quantized using resource blocks or resource elements of an orthogonal frequency-division multiplexing (OFDM) communication scheme.

4. The method of claim 1, wherein the resource information comprises the resource capability map, and wherein the resource information further comprises one or more resource parameters indicative of:
a bandwidth, coding, duration, periodicity, or any combination thereof, with which the respective UE is capable of transmitting SL positioning signals;
a bandwidth, coding, duration, periodicity, or any combination thereof, with which the respective UE is capable of measuring the SL positioning signals;
a capability of the respective UE to perform simultaneous measurements of multiple SL positioning signals; or
any combination thereof.

5. The method of claim 1, wherein the resource information comprises the resource usage map, and wherein the resource information further comprises one or more resource parameters indicative of:
a bandwidth, coding, duration, periodicity, or any combination thereof, with which the respective UE is configured to transmit SL positioning signals;
a bandwidth, coding, duration, periodicity, or any combination thereof, with which the respective UE is configured to measure the SL positioning signals; or
any combination thereof.

6. The method of claim 1, wherein the resource information further comprises an indication of an average level of background radio frequency (RF) activity from other entities at each frequency of a plurality of frequencies.

7. The method of claim 1, wherein the coordinating entity comprises a coordinating UE or a location server.

8. The method of claim 7, wherein the coordinating entity comprises the coordinating UE, and wherein the plurality of UEs includes the coordinating UE.

9. The method of claim 1, wherein the resource information comprises the resource usage map, and wherein time information included in the resource usage map includes only information corresponding to SL positioning occasions.

10. The method of claim 1, wherein the SL positioning configuration for each respective UE in the plurality of UEs comprises:
an SL Positioning Reference Signal (PRS) configuration to be transmitted by the respective UE;
a plurality of SL PRS configurations to be measured by the respective UE, wherein each SL PRS configuration in the plurality of SL PRS configurations is transmitted by some other UE in the plurality of UEs; or
both of these.

11. The method of claim 1, wherein obtaining the resource information for each of the plurality of UEs comprises receiving the resource information from each of the plurality of UEs, that is not the coordinating entity, in a Sidelink Positioning Protocol (SLPP) message.

12. The method of claim 1, wherein providing the SL positioning configuration to each respective UE of the plurality of UEs comprises sending the resource information to the respective UE in a Sidelink Positioning Protocol (SLPP) message, when the respective UE is not the coordinating entity.

13. A method performed by a user equipment (UE) for sidelink (SL) positioning, the method comprising:
determining resource information, the resource information comprising either or both of:
a resource capability map indicative of the UE's capability of transmitting an SL positioning signal, measuring an SL positioning signal, or both, using one or more frequencies; or
a resource usage map indicative of the UE's currently scheduled usage of SL positioning frequency and time resources, the scheduled usage comprising transmitting an SL positioning signal, measuring an SL positioning signal, or both; and
providing the resource information to an entity coordinating SL positioning among a plurality of UEs, the plurality of UEs including the UE.

14. The method of claim 13, wherein the resource information comprises the resource capability map, and the one or more frequencies are quantized using resource blocks or resource elements of an orthogonal frequency-division multiplexing (OFDM) communication scheme.

15. The method of claim 13, wherein the resource information comprises the resource usage map, and the SL positioning frequency and time resources are quantized using resource blocks or resource elements of an orthogonal frequency-division multiplexing (OFDM) communication scheme.

16. The method of claim 13, wherein the resource information comprises the resource capability map, and wherein the resource information further comprises one or more resource parameters indicative of:
a bandwidth, coding, duration, periodicity, or any combination thereof, with which the UE is capable of transmitting SL positioning signals;
a bandwidth, coding, duration, periodicity, or any combination thereof, with which the UE is capable of measuring SL positioning signals;
a capability of the UE to perform simultaneous measurements of multiple SL positioning signals; or
any combination thereof.

17. The method of claim 13, wherein the resource information comprises the resource usage map, and wherein the resource information further comprises one or more resource parameters indicative of:
a bandwidth, coding, duration, periodicity, or any combination thereof, with which the UE is configured to transmit SL positioning signals;
a bandwidth, coding, duration, periodicity, or any combination thereof, with which the UE is configured to measure SL positioning signals; or
any combination thereof.

18. The method of claim 13, wherein the resource information further comprises an indication of an average level of background radio frequency (RF) activity from other entities at each frequency of a plurality of frequencies, as detected by the UE.

19. The method of claim 13, wherein the resource information comprises the resource usage map, and wherein time information included in the resource usage map includes only information corresponding to SL positioning occasions.

20. The method of claim 13, wherein providing the resource information to the entity coordinating SL positioning among the plurality of UEs comprises sending the resource information to the entity coordinating SL positioning among the plurality of UEs in a Sidelink Positioning Protocol (SLPP) message when the UE is not the entity coordinating SL positioning among the plurality of UEs.

21. The method of claim 13, further comprising obtaining an SL positioning configuration from the entity coordinating SL positioning among the plurality of UEs, wherein the SL positioning configuration is based at least in part on the resource information.

22. A coordinating entity comprising:
at least one transceiver;
at least one memory; and
at least one processor communicatively coupled with the at least one transceiver and at least one memory, the at least one processor configured to:
obtain resource information for each of a plurality of user equipments (UEs), wherein, for each respective UE of the plurality of UEs, the resource information comprises either or both of:
a resource capability map indicative of the respective UE's capability of transmitting a sidelink (SL) positioning signal, measuring an SL positioning signal, or both, using one or more frequencies; or
a resource usage map indicative of the respective UE's currently scheduled usage of SL position frequency and time resources, the scheduled usage comprising transmitting an SL positioning signal, measuring an SL positioning signal, or both;
determine an SL positioning configuration for each respective UE of the plurality of UEs, wherein the determining is based at least in part on the resource information obtained for each of the plurality of UEs; and
provide the SL positioning configuration via the at least one transceiver to each respective UE of the plurality of UEs.

23. The coordinating entity of claim 22, wherein, to obtain the resource information comprising the resource capability map, the at least one processor is configured to obtain information in which the one or more frequencies are quantized using resource blocks or resource elements of an orthogonal frequency-division multiplexing (OFDM) communication scheme.

24. The coordinating entity of claim 22, wherein, to obtain the resource information comprising the resource usage map, the at least one processor is configured to obtain information in which the SL positioning frequency and time resources are quantized using resource blocks or resource elements of an OFDM communication scheme.

25. The coordinating entity of claim 22, wherein the at least one processor is configured to obtain one or more resource parameters in the resource information when the resource information comprises the resource capability map, the one or more resource parameters indicative of:
a bandwidth, coding, duration, periodicity, or any combination thereof, with which the respective UE is capable of transmitting SL positioning signals;
a bandwidth, coding, duration, periodicity, or any combination thereof, with which the respective UE is capable of measuring the SL positioning signals;
a capability of the respective UE to perform simultaneous measurements of multiple SL positioning signals; or
any combination thereof.

26. The coordinating entity of claim 22, wherein the at least one processor is configured to obtain one or more resource parameters in the resource information when the resource information comprises the resource usage map, the one or more resource parameters indicative of:
a bandwidth, coding, duration, periodicity, or any combination thereof, with which the respective UE is configured to transmit SL positioning signals;
a bandwidth, coding, duration, periodicity, or any combination thereof, with which the respective UE is configured to measure the SL positioning signals; or
any combination thereof.

27. The coordinating entity of claim 22, wherein the at least one processor is configured to obtain, from the resource information, an indication of an average level of background radio frequency (RF) activity from other entities at each frequency of a plurality of frequencies.

28. A user equipment (UE) comprising:
at least one transceiver;
at least one memory; and
at least one processor communicatively coupled with the at least one transceiver and at least one memory, the at least one processor configured to:
determine resource information, the resource information comprising either or both of:
a resource capability map indicative of the UE's capability of transmitting a sidelink (SL) positioning signal, measuring an SL positioning signal, or both, using one or more frequencies;
a resource usage map indicative of the UE's currently scheduled usage of SL position frequency and time resources, the scheduled usage comprising transmitting an SL positioning signal, measuring an SL positioning signal, or both; and
provide the resource information via the at least one transceiver to an entity coordinating SL positioning among a plurality of UEs, the plurality of UEs including the UE.

29. The UE of claim 28, wherein, to provide the resource information comprising the resource capability map, the at least one processor is configured to quantize to and the one or more frequencies using resource blocks or resource elements of an orthogonal frequency-division multiplexing (OFDM) communication scheme.

30. The UE of claim 28, wherein, to provide the resource information comprising the resource usage map, the at least one processor is configured to quantize the SL positioning frequency and time resources using resource blocks or resource elements of an OFDM communication scheme.
